(19) United States
(12) Patent Application Publication
(10) Pub. No.: US 2013/0280152 A1
(43) Pub. Date: Oct. 24, 2013

(54) Method and Apparatus for the Removal of Carbon Dioxide from a Gas Stream

(71) Applicant: Uday Singh, San Clemente, CA (US)

(72) Inventor: Uday Singh, San Clemente, CA (US)

(21) Appl. No.: 13/923,289

(22) Filed: Jun. 20, 2013

Related U.S. Application Data
(63) Continuation-in-part of application No. 12/513,080, filed on Apr. 30, 2009.
Application No. 12/513,080 is a continuation-in-part of application No. 11/875,747, filed on Oct. 19, 2007, now Pat. No. 7,964,170.
(60) Provisional application No. 61/024,083, filed on Jan. 28, 2008.

(51) Int. Cl. B01D 53/62

(52) U.S. Cl. CPC B01D 53/62
USPC 423/232; 423/437.1; 423/496

(57) ABSTRACT

The invention provides methods and apparatuses for removing carbon dioxide from a gas stream. In particular, the invention provides methods and apparatuses for absorbing carbon dioxide from a coal-fired boiler flue gas stream using an absorbing solution and for regeneration of an alkaline component used in the absorbing solution. In one embodiment, the invention provides a method for removing carbon dioxide from a gas stream by contacting a gas stream containing carbon dioxide with an alkaline liquid stream; absorbing at least a portion of the carbon dioxide into the alkaline liquid stream to produce absorbed carbon dioxide; and catalyzing a reaction of the absorbed carbon dioxide to a form of carbonate. In other embodiments, the invention provides a method for producing salable calcium carbonate, calcium chloride, and carbon dioxide gas.

### CROSS-REFERENCES TO RELATED APPLICATIONS

This application is a continuation-in-part of U.S. application Ser. No. 12/513,080, which was the National Stage of International Application No. PCT/US08/80207, filed Oct. 16, 2008, which claims the benefit under 35 U.S.C. §119(e) of U.S. Provisional Application 61/024,083, filed Jan. 28, 2008 and which claims the benefit under 35 U.S.C. §120 and is a continuation-in-part of U.S. Non-Provisional application Ser. No. 11/875,747, filed Oct. 19, 2007. Each of the foregoing applications is hereby incorporated by reference herein in its entirety.

### BACKGROUND

1. Background of the Invention

The invention relates generally to methods and apparatuses for removing carbon dioxide from a gas stream and sequestering the captured carbon dioxide gas. In particular, the invention relates to methods and apparatuses for absorbing carbon dioxide from a coal-fired boiler flue gas stream using an absorbing solution, for regeneration of an alkaline component used in the absorbing solution, and for producing the captured carbon dioxide as a salable gas or as a salable mineral.

2. Description of Related Art

Certain gaseous or vapor phase pollutants are routinely removed from gas streams emitted by various sources, such as power, chemical, and manufacturing plants, before such gas streams are released into the atmosphere. For example, sulfur dioxide is routinely removed from flue gas generated by coal-fired power plants. However, concerns have recently arisen about the release of carbon dioxide into the atmosphere from various sources such as coal-fired power plants. Specifically, carbon dioxide has been identified as a greenhouse gas and as a contributor to global warming. Accordingly, it is desirable to reduce carbon dioxide emissions, for example, by removing it from gas streams emitted by these various sources, such as coal-fired power plants. While there are various technologies available for removing carbon dioxide from a gas stream, improvements in removal efficiency and cost can still be achieved, and new technologies still need to be developed.

### SUMMARY OF THE INVENTION

The invention provides methods and apparatuses for removing carbon dioxide from a gas stream. In particular, the invention provides methods and apparatuses for absorbing carbon dioxide from a coal-fired boiler flue gas stream using an absorbing solution and for regeneration of an alkaline component used in the absorbing solution.

In one embodiment, the invention provides a method for removing carbon dioxide from a gas stream, comprising contacting a gas stream containing carbon dioxide with an alkaline liquid stream; absorbing at least a portion of the carbon dioxide into the alkaline liquid stream to produce absorbed carbon dioxide; and catalyzing a reaction of the absorbed carbon dioxide to a form of carbonate.

In other embodiments, a wet electrostatic precipitator is used to remove the carbon dioxide from the gas stream. In addition, various modifications to the operation of the wet electrostatic precipitator are used to oxidize and remove elemental mercury from the gas stream.

In another embodiment, the invention provides methods for removing carbon dioxide from a gas stream and producing a carbon dioxide rich gas stream that can be used for other commercial purposes, including the production of a salable gas.

In another embodiment, the invention provides a method for removing carbon dioxide from a gas stream and producing a salable calcium chloride solid product.

### BRIEF DESCRIPTION OF THE DRAWINGS

FIG. 1 illustrates a coal-fired boiler and flue gas treatment process incorporating an embodiment of the present invention;

FIG. 2 illustrates a process comprising a carbon dioxide absorber and related process equipment for implementing an embodiment of the present invention;

FIG. 2A illustrates a process comprising a wet electrostatic precipitator as a carbon dioxide absorber and related process equipment for implementing another embodiment of the present invention;

FIG. 3 illustrates a series of carbon dioxide absorbers and related process equipment for implementing another embodiment of the present invention;

FIG. 4 illustrates a carbon dioxide absorber having a vertical stage and a horizontal stage for implementing another embodiment of the present invention;

FIG. 5 illustrates a carbon dioxide absorber with two stages for implementing another embodiment of the present invention;

FIG. 5A illustrates another carbon dioxide absorber with two stages for implementing another embodiment of the present invention;

FIG. 5B illustrates another carbon dioxide absorber with two stages for implementing another embodiment of the present invention;

FIG. 5C illustrates another carbon dioxide absorber with multiple stages for implementing another embodiment of the present invention;

FIG. 6 illustrates a process for the removal of sulfur dioxide and carbon dioxide according to one embodiment of the present invention;

FIG. 6A illustrates another process for the removal of sulfur dioxide and carbon dioxide according to another embodiment of the present invention;

FIG. 7 illustrates a process for regenerating reagent for use in an embodiment of the present invention;

FIG. 8 illustrates a process for producing gaseous carbon dioxide according to one embodiment of the present invention;

FIG. 9 illustrates a process for removing sulfur dioxide and chloride from a gas stream upstream of a carbon dioxide absorber to produce salable calcium chloride according to one embodiment of the present invention; and

FIG. 10 illustrates another process for producing gaseous carbon dioxide according to one embodiment of the present invention.

### DETAILED DESCRIPTION OF THE INVENTION

Generally, the invention comprises various methods and apparatuses for removing carbon dioxide from a gas stream using an absorbing solution and for regeneration of an alkaline component used in the absorbing solution. The various embodiments are described below in conjunction with the Figures; however, this description should not be viewed as limiting the scope of the present invention. Rather, it should be considered exemplary of various embodiments that fall within the scope of the present invention as defined by the claims. For example, the various embodiments of the invention are described below in the context of the removal of carbon dioxide from a flue gas stream generated by a coal-fired boiler. However, the various methods and apparatuses for removing carbon dioxide can be applied to any gas stream generated by any means or from any source.

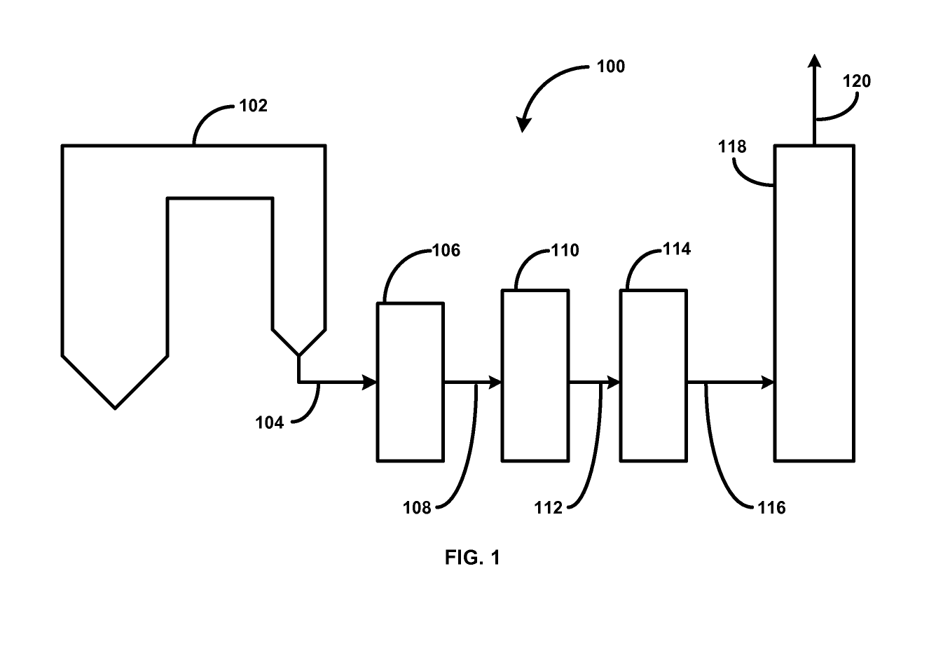

FIG. 1 illustrates a coal-fired boiler and flue gas treatment process incorporating an embodiment of the present invention. The coal-fired boiler and flue gas treatment process 100 comprises a coal-fired boiler 102 that combusts coal to produce steam for use in generating electricity. The combustion process produces a flue gas comprising certain components that need to be removed, at least partially, from the flue gas before it is released into the atmosphere. Some of these components include fly ash or particulate matter, which includes particles smaller than 1 micron in size, sulfur dioxide, sulfur trioxide, and carbon dioxide, as well as other trace contaminants such as mercury.

The flue gas exits the boiler 102 through a boiler outlet gas duct 104 that carries the flue gas to a particulate collection device 106. The particulate collection device 106 removes at least a portion of the fly ash or particulate matter from the flue gas. The particulate collection device 106 may be any device capable of removing the fly ash or particulate matter, such as a wet electrostatic precipitator, a dry electrostatic precipitator, or a baghouse or fabric filter. It should be appreciated that the amount of fly ash or particulate matter removal may vary. For example, the concentration of the fly ash or particulate matter in the flue gas and the type and operating conditions of the particulate collection device 106, as well as other operating parameters and conditions, may each affect the amount of fly ash or particulate matter removed from the flue gas. The flue gas exits the particulate collection device 106 through a particulate collection device outlet gas duct 108 that carries the flue gas to a sulfur dioxide absorber 110.

The sulfur dioxide absorber 110 removes at least a portion of the sulfur dioxide from the flue gas. The sulfur dioxide absorber 110 may be any gas/liquid contactor capable of removing sulfur dioxide from the flue gas, such as a spray tower, tray tower, or a packed bed tower. The sulfur dioxide absorber 110 may also be a spray dryer; however, in this case a particulate collection device would be positioned downstream of the spray dryer rather than upstream as shown in FIG. 1. Various reagents may be used in each of these contactors, including lime and limestone, as well as other additives used in conjunction with these reagents, such as oxidation and pH control additives. It should be appreciated that the amount of removal of sulfur dioxide may vary. For example, the concentration of sulfur dioxide in the flue gas and the type and operating conditions of the sulfur dioxide absorber 110, as well as other operating parameters and conditions, may each affect the amount of sulfur dioxide removed. The flue gas exits the sulfur dioxide absorber 110 through a sulfur dioxide absorber outlet gas duct 112 that carries the flue gas to a carbon dioxide absorber 114.

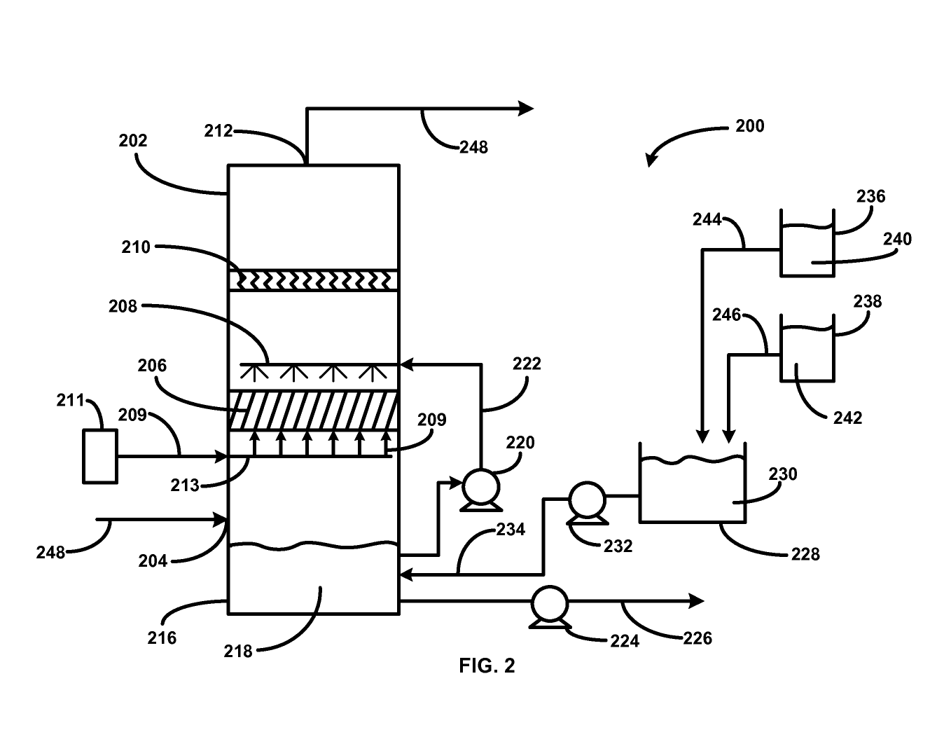

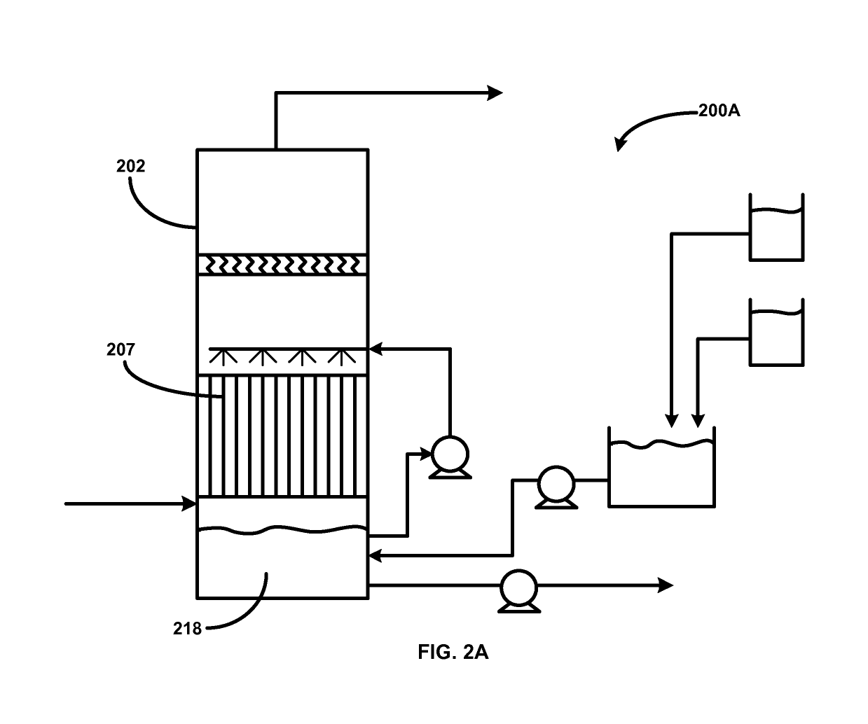

The carbon dioxide absorber 114 removes at least a portion of the carbon dioxide from the flue gas using an alkaline liquid stream or slurry, generally referred to below as an absorbing solution. In some embodiments, 90% or more, 95% or more, or 99% or more of the carbon dioxide is removed. The carbon dioxide absorber 114 may be any gas/liquid contactor capable of removing carbon dioxide from the flue gas, such as a spray tower, tray tower, packed bed tower, or a spray dryer, and such gas/liquid contactor may be designed for vertical or horizontal gas flow and for either countercurrent, co-current, or cross-current gas flow relative to the flow of the absorbing solution. It should also be appreciated that the carbon dioxide absorber 114 may comprise one or more gas/liquid contactors. Various embodiments and aspects of the carbon dioxide absorber 114, including its configuration and operation are described further below in connection with FIGS. 2-6.

It should be appreciated that a wet electrostatic precipitator may also be used as the carbon dioxide absorber, in which case the concurrent removal of particulate matter, carbon dioxide, and sulfur trioxide may be achieved. In fact, testing at an operating coal-fired power plant has demonstrated significant particulate and sulfur trioxide reductions in the flue gas using a wet electrostatic precipitator. The removal efficiency of the particulate matter was 97.3%, noting that the particulate matter in the flue gas stream contained approximately 61% by weight of particles less than 1 micron in size. The removal of sulfur trioxide was such that the sulfur trioxide concentration at the stack was less than 0.0292 parts per million or well below 1 part per million. It should be appreciated that the system effectively removed what little sulfur trioxide entered and would reduce higher levels to the same absolute level, resulting in very high percentage removal.

After passing through the carbon dioxide absorber 114, the flue gas exits the carbon dioxide absorber 114 through a carbon dioxide absorber outlet duct 116 that carries the flue gas to a stack 118. The flue gas 120 exits the stack 118 where it is discharged to the atmosphere.

FIG. 2 illustrates a process comprising a carbon dioxide absorber and related process equipment for implementing an embodiment of the present invention. The process 200 comprises a carbon dioxide absorber 202, illustrated as a packed bed absorber, that contacts the flue gas with an alkaline liquid stream or slurry, generally referred to as an absorbing solution, to absorb carbon dioxide from the flue gas. The packed bed absorber 202 is one example of the carbon dioxide absorber 114 illustrated in FIG. 1; however, other absorber designs, such as a spray tower, tray tower, packed bed tower, a spray dryer, a wet electrostatic precipitator, or any combination of these, may be used. The packed bed absorber 202 comprises a flue gas inlet duct 204, a packed bed 206, a bank of nozzles 208, a mist eliminator 210 positioned above the packed bed 206 and the nozzles 208, and a flue gas outlet duct 212. Again, it should be appreciated that the packed bed absorber 202 or any other absorber design, including a wet electrostatic precipitator, may be used to remove carbon dioxide from other types of gas streams and is not limited to use with flue gas streams from coal-fired boilers.

The packed bed 206 may be any packed bed known in the art, including any packing material known in the art, that provides sufficient gas/liquid contact between the flue gas and the absorbing solution. In some embodiments, high efficiency packing with low pressure drop across the packing may be used to minimize the size and operating costs of the packed bed. The nozzles 208 may also be any type of nozzle or any other equipment capable of distributing an absorbing solution over the packed bed 204. In some embodiments, a gas 209 from a gas source 211 optionally may be injected through a gas manifold 213 into the bottom of the packed bed 206 to provide agitation to the gas and liquid in the packed bed 206, thereby increasing the amount of contact between the gas and the liquid. This gas 209 may be a compressed gas, such as compressed ambient air, or any other gas provided such gas does not deleteriously affect the operation of the packed bed 206 or the carbon dioxide absorber 202. The mist eliminator 210 may also be any mist eliminator design known in the art, including a wet electrostatic precipitator.

The bottom of the packed bed absorber 202 serves as a reaction tank 216 that collects the absorbing solution 218. An absorbing solution recirculation pump 220 is used to recirculate the absorbing solution 218 through a recirculation line 222 that extends from the reaction tank 216 to the nozzles 208. A blowdown pump 224 is used to discharge a portion of the absorbing solution 218 from the reaction tank 216 through a discharge or blowdown line 226. It should be appreciated that the reaction tank 216 may or may not be integral to the packed bed absorber. Further, the size of the reaction tank 216 can be designed to provide the desired residence time for the absorbing solution. In some embodiments, the reaction tank may be designed to provide a residence time of approximately 3 to approximately 15 minutes. In some embodiments, the residence time is approximately 10 to approximately 15 minutes. In other embodiments, the residence time is approximately 10 minutes.

A reagent feed tank 228 is used to hold an alkaline reagent 230 that is added to the absorbing solution. A reagent feed pump 232 is used to feed the reagent 230 to the reaction tank 216 through a reagent feed line 234. Chemical feed tanks 236, 238 are used to hold various chemical solutions 240, 242, respectively, that are added to the reagent 230 in the reagent feed tank 228 through chemical feed lines 244, 246, respectively. In one embodiment, one of the chemical solutions 240 comprises an alkaline component that is added to the reagent feed tank 228 to provide the reagent 230 with its alkalinity. In other words, one component of the reagent 230 is an alkaline component. Accordingly, as the reagent 230 is fed to the reaction tank 216, the alkaline component will also be added to the absorbing solution 218. It should be appreciated that additional process equipment, such as surge tanks, necessary to maintain an appropriate pressure head for the various pumps, may also be used.

In operation, a flue gas 248 comprising carbon dioxide, such as a flue gas from a coal-fired boiler, enters the packed bed absorber 202 at the flue gas inlet duct 204 and travels through the packed bed 206, through the mist eliminator 210, and through the flue gas outlet duct 212. Concurrently with the flow of the flue gas 248 through the packed bed absorber 202, the absorbing solution 218 is continuously pumped from the reaction tank 216 through the recirculation line 222 using the absorbing solution recirculation pump 220 to deliver the absorbing solution to the bank of nozzles 208. As the absorbing solution 218 exits the nozzles 208, the absorbing solution 218 is distributed over the top of the packed bed 206. The absorbing solution 218 travels through the packed bed 206 and is collected in the reaction tank 216 at the bottom of the packed bed absorber 202. In this embodiment, the direction of gas flow and the direction of flow of the absorbing solution are countercurrent. However, it should be appreciated that the relative direction of the gas flow and absorbing solution flow may be co-current or cross-current depending upon the absorber design. Moreover, it should be appreciated that the gas flow may also be vertical (upward or downward) or horizontal relative to the ground depending upon the absorber design.

The flow rate of the absorbing solution 218 through the packed bed absorber 202 can be changed depending upon the desired amount of carbon dioxide to be removed from the flue gas 248. A relatively higher removal percentage of carbon dioxide removal can be achieved by increasing the flow rate of the absorbing solution 218 through the packed bed absorber 202. Other factors that will affect the amount of carbon dioxide removal include the flow rate of the flue gas 248, the concentration of carbon dioxide in the flue gas 248, and the sufficiency of contact between the flue gas 248 and the absorbing solution 218 or the mass transfer characteristics of the packed bed absorber 202. Accordingly, for a given carbon dioxide absorber design and operating parameters (e.g., flue gas flow rate, carbon dioxide concentration in the flue gas), the flow rate of the absorbing solution can be determined to provide a given amount of carbon dioxide removal or rate of carbon dioxide removal.

The ratio of the flow rate of the absorbing solution 218 to the flow rate of the flue gas 248 is referred to as the “L/G” ratio. For the configuration shown in FIG. 2, this ratio is expected to be within the range of approximately 3 to approximately 20 and for some other embodiments this ratio is expected to be within the range of approximately 6 to approximately 15. In still other embodiments, the L/G ratio may be approximately 15 or greater. As noted above, since many factors affect the L/G ratio actually used, it should be appreciated that the L/G ratio will be different for different carbon dioxide absorber designs and operating parameters. Also, as noted above, the L/G ratio will need to be considered in the design of the size of the reaction tank 216 since it will affect the residence time of the absorbing solution 218 in the reaction tank 216.

As the flue gas 248 passes through the packed bed 206 and as the absorbing solution 218 travels through the packed bed 206, the flue gas 248 and the absorbing solution 218 are brought into intimate contact. During this contact, carbon dioxide is absorbed from the flue gas 248 into the absorbing solution 218. One of skill in the art will appreciate that the amount of gas/liquid contact is based upon the design of the packed bed 206 and the type of packing material used, as well as the relative flow rates of the flue gas 248 and the absorbing solution 218 through the packed bed absorber 202 and the packed bed 206.

Upon absorption of the carbon dioxide into the absorbing solution 218, the absorbed carbon dioxide will initially react with water in the absorbing solution to produce carbonic acid. Accordingly, the pH of the absorbing solution 218 will decrease as more and more carbon dioxide is absorbed. Therefore, it is desirable to use an absorbing solution 218 that is alkaline to increase the capacity of the absorbing solution to absorb carbon dioxide. In addition, it is desirable to maintain and control the amount of alkalinity in the absorbing solution 218 as carbon dioxide is absorbed. In one embodiment, the amount of alkalinity in the absorbing solution 218 is determined using a pH measurement, and the amount alkalinity in the absorbing solution 218 is maintained by controlling the pH of the absorbing solution 218 at a predetermined value as described below.

The amount of alkalinity and, therefore, the pH to be maintained in the absorbing solution may vary depending upon a variety of factors, including, for example, the concentration of the carbon dioxide in the flue gas 218, the desired amount of carbon dioxide removal from the flue gas 218, and the actual amount of carbon dioxide removed.

In some embodiments, the pH of the absorbing solution 218 is controlled at approximately 7.0 or greater and in some embodiments between approximately 8.0 to approximately 11.0. At a pH of approximately 8.3-8.5, there is no carbon dioxide off-gassing from the absorbing solution. Therefore, in other embodiments, the pH of the absorbing solution is controlled at approximately 8.3 or greater, approximately 8.5 or greater, or between approximately 8.3 to approximately 8.5.

In one embodiment, the pH of the absorbing solution 218 is controlled by the addition of the alkaline reagent 230 to the absorbing solution 218, which is done by feeding the reagent 230 to the reaction tank 216 based upon a pH feedback control loop (not shown). In this embodiment, the pH of the absorbing solution 218 is measured, and, as the pH drops below a predetermined value, the reagent 230 is added to the absorbing solution 218 via the reaction tank 216. The pH may be measured in the reaction tank 216 or in the recirculation line 222. Alternatively, the reagent 230 may be added to the recirculation line 222.

The alkaline reagent 230 comprises at least water and an alkaline component and, in one embodiment, may be generated by mixing water and the alkaline component in the reagent feed tank 228. The alkaline component may be any alkaline chemical or mixture of alkaline chemicals that will provide alkalinity to the absorbing solution 218 and thereby allow for control of the pH of the absorbing solution. In one embodiment, the alkaline component is sodium hydroxide. In another embodiment, the alkaline component is calcium hydroxide. In other embodiments, the alkaline component may be either sodium hydroxide, calcium hydroxide, and an additional alkaline chemical or a mixture of any of the foregoing. In yet other embodiments, the alkaline component may be magnesium hydroxide or potassium hydroxide or any combination of any of the foregoing alkaline components. The alkaline component may be held in one of the chemical feed tanks 236 and added to the reagent feed tank 228 when necessary. In other words, whenever reagent 230 is needed, or if the amount of reagent 230 in the reagent feed tank 228 has fallen below a predetermined level, water and the alkaline component may be added to the reagent feed tank 228 and mixed to produce the reagent 230.

One of skill in the art will appreciate that the concentration of the alkaline component in the reagent 230 may vary depending upon various factors, including the amount of carbon dioxide removal and the corresponding rate at which the reagent 230 must be added to the absorbing solution 218 to maintain a given pH, as well as the overall material balance, including the water balance, of the overall process 200 or the process in which the packed bed absorber 202 is used, such as the process shown in FIG. 1. In some embodiments using sodium hydroxide as the alkaline component, the concentration of sodium hydroxide in the reagent may range from approximately 0.1 Normal to approximately 4 Normal or greater. In some embodiments using calcium hydroxide as the alkaline component, the concentration of the calcium hydroxide solids in the reagent may range from approximately 10% by weight solids to approximately 12% by weight solids.

Accordingly, the concentration of the alkaline component 240 in the chemical feed tank 236 can also be adjusted depending upon these same factors. In some embodiments wherein the alkaline component comprises sodium hydroxide, the concentration of the sodium hydroxide 240 in the chemical feed tank 236 may range from approximately 0.1 Normal to approximately 4 Normal sodium hydroxide or greater and in other embodiments from approximately 1 Normal to approximately 2 Normal sodium hydroxide. In some embodiments wherein the alkaline component comprises calcium hydroxide, the solution in the chemical feed tank 236 will be a slurry comprising calcium hydroxide solids at a concentration that may range from approximately 10% by weight solids to approximately 12% by weight solids or greater. When using calcium hydroxide as the alkaline component in the reagent, it should be appreciated that the absorbing solution will also contain solids and may be referred to as a slurry.

In the embodiment in which the alkaline component 240 comprises sodium hydroxide, the absorption of carbon dioxide and its reaction with the absorbing solution 218 comprising sodium hydroxide is shown by Equations (1)-(3):

CO₂(g)+H₂O(l) [symbol] H₂CO₃(l) Eq. (1)

H₂CO₃+NaOH [symbol] Na⁺+HCO₃⁻+H₂O Eq. (2)

HCO₃⁻+NaOH [symbol] Na⁺+CO₃⁼+H₂O Eq. (3)

As shown, the absorbed carbon dioxide gas reacts with water to form carbonic acid followed by the liquid phase reactions with the sodium hydroxide to form a mixture of both sodium bicarbonate (Eq. 2) and sodium carbonate (Eq. 3). It should be appreciated that the bicarbonate and carbonate are in equilibrium with each other based upon the pH of the absorbing solution. Therefore, while these reactions are reversible, at approximately pH 8.3, there is a reduced amount of carbonic acid in the absorbing solution, as Equation (2) is shifted in favor of the formation of sodium bicarbonate. Accordingly, at this pH or higher there would be little to no off-gassing of carbon dioxide. It should be appreciated that similar reactions would occur if the alkaline component were magnesium or potassium hydroxide by substituting the corresponding cation.

In the embodiment in which the alkaline component 240 comprises calcium hydroxide, the absorption of carbon dioxide and its reaction with the absorbing solution 218 comprising calcium hydroxide is shown by Equations (4)-(6):

CO₂(g)+H₂O(l) [symbol] H₂CO₃(l) Eq. (4)

2H₂CO₃+Ca(OH)₂ [symbol] Ca⁺+2HCO₃⁻+2H₂O Eq. (5)

2HCO₃⁻+Ca(OH)₂ [symbol] Ca⁺+2 CO₃⁻+2H₂O Eq. (6)

As shown, the absorbed carbon dioxide gas reacts with water to form carbonic acid followed by the liquid phase reactions with dissolved calcium hydroxide to form a mixture of both calcium bicarbonate (Eq. 2) and calcium carbonate (Eq. 3). While these reactions are reversible, at a pH of approximately 8.2 to approximately 8.3 there is a reduced amount of carbonic acid in the absorbing solution, as Equation (2) is shifted in favor of the formation of calcium bicarbonate. Accordingly, at this pH range and higher there would be little to no off-gassing of carbon dioxide.

Once the process 200 reaches steady-state operation, the absorbing solution 218 will contain certain concentrations of bicarbonate and carbonate ions and the corresponding cations depending upon the alkaline component used. As noted above, the use of calcium hydroxide as the alkaline component will result in calcium as the primary cation. In this case, the absorbing solution 218 will also comprise solids. Also, it should be appreciated that the absorbing solution 218 may also comprise other chemicals in significant or trace concentrations depending upon such factors as the amount of particulate matter or fly ash and other gaseous species removed by the packed bed absorber 202 from the flue gas 248 and the amount of other chemicals that enter the system with the reagent 230 or water used in the reagent 230. Therefore, the absorbing solution 218 may contain other liquid phase chemicals as well as other solids. Accordingly, the terms “alkaline liquid stream” and “absorbing solution” are intended to include liquid streams, as well as liquid streams comprising solids, such as slurries.

It should be appreciated that water is produced by the absorption of carbon dioxide, as shown in Equations 2 and 3 and Equations 4 and 5 above. Depending upon the chemical components in the absorbing solution and the overall water balance in the process, it may be possible to reuse this generated or excess water, depending upon the overall water balance of the process. For example, in a process that includes a flue gas desulfurization system, a portion of the absorbing solution that is discharged from the reaction tank as blowdown may be used as make-up water. Of course, the absorbing solution may also be filtered and chemically treated to provide water having an acceptable chemical composition for use elsewhere.

In one embodiment, one of the chemical feed tanks 238 may be used to hold a catalyst 242 that is optionally added to the reagent feed tank 230 and fed to the absorbing solution 218 with the reagent 230. This catalyst 242 is used to catalyze the absorption of carbon dioxide. Without being limited by theory, it is believed that the carbon dioxide absorption rate is limited by the solubility of carbon dioxide in water, and by the relatively low rate of reaction of the carbon dioxide in the liquid phase after it has been absorbed. Therefore, once the carbon dioxide has partially dissolved in water, the reaction rate within the liquid phase is increased by the use of catalyst. In particular, it is believed that the catalyst increases the rate of reaction of the carbonic acid and the bicarbonate with the alkaline component, as shown by Equations (2) and (3) and Equations (5) and (6) above.

The catalyst, however, may be any catalyst that increases the rate of absorption of carbon dioxide. In some embodiments, the catalyst comprises a monosaccharide, such as levulose or dextrose. In other embodiments, the catalyst comprises a disaccharide, such as sucrose and lactose. In other embodiments, the catalyst comprises an alcohol, such as ethylene glycol, glycerol, methyl alcohol, and ethyl alcohol. In other embodiments, the catalyst comprises an aldehyde, such as formaldehyde. In other embodiments, the catalyst comprises a mixture of any of a monosaccharide, a disaccharide, an alcohol, and an aldehyde. In other embodiments, the catalyst comprises sucrose, dextrose, ethanol, methanol, ethylene glycol, levulose, glycerol, lactose, and any mixture or combination of any of the foregoing. In still other embodiments, the catalyst may comprise an enzyme that catalyses the conversation of carbon dioxide to bicarbonate or other products. For example, carbonic anhydrase, which is a family of metalloenzymes or enzymes containing one or more metals or other functional components at an active site, may be used. The metals may include cadmium, zinc, or other ions, and may include mixtures of these metals and ions as well. The use of carbonic anhydrase may be particularly useful in combination with potassium hydroxide as the alkaline component.

As noted, the catalyst may be added to the reagent feed tank 228 from a chemical feed tank 238. Alternatively, the catalyst may be added directly to the reaction tank 216, directly to the recirculation line 222 separately from the reagent feed line 234, or directly to the alkaline component 240 being held in one of the chemical feed tanks 236. The concentration of catalyst necessary in the absorbing solution 218 is any amount that improves the rate of removal of carbon dioxide removal from the flue gas 248, which can be determined simply by measuring the amount of carbon dioxide removal across the packed bed absorber 202. Furthermore, the actual concentration of the catalyst in the absorbing solution 218 may not need to be measured, as one of skill in the art will appreciate that various concentrations of the catalyst in the chemical feed tank 238 and various rates of addition of the catalyst to either the reagent feed tank 230 or to the reaction tank 216 or the recirculation line 222 may be used to determined the absolute amount and rate of catalyst that needs to be fed to the absorbing solution 218 to enhance the rate of carbon dioxide removal. In some embodiments, the concentration of the catalyst is approximately 0.01% to approximately 1.0% of the absorbing solution.

As the process 200 continues to operate, the absorbing solution 218 is recirculated multiple times or makes multiple passes through the absorber 202. The rate at which the absorbing solution 218 is recirculated is determined by the desired L/G ratio, as described above. During each pass, an additional increment of carbon dioxide is absorbed resulting in the formation of more bicarbonate and carbonate that must be removed from the absorption solution and replaced by the addition of reagent and fresh alkaline component to maintain the a desired reactivity or alkalinity of the absorbing solution. This is accomplished by discharging a portion of the absorbing solution 218 through the blowdown line 226 at a selected rate. This rate will depend upon the removal rate of carbon dioxide and the corresponding increase in concentration of reaction products such as bicarbonates and carbonates and the overall system water balance. This discharge or blowdown stream ultimately may be passed to a set of hydroclones and thickeners or to a storage tank (not shown) for ultimate disposal. In some embodiments in which potassium hydroxide is used as the alkaline component, the blowdown stream will contain potassium ions, which may make the blowdown stream saleable in the fertilizer industry, for example, as a soil amendment. This stream may be either sold in its current form or water may be evaporated to concentrate the potassium ions and minimize transportation costs. For example, the blowdown stream comprising potassium ions may be sent to an evaporation pond where the water is evaporated and the remaining solids are scraped together and sold.

The hydroclones and thickeners are particularly useful for those embodiments in which solids are present in the absorbing solution, such as systems using calcium hydroxide as the alkaline component. In these cases, the blowdown stream will also contain solids, including carbonate solids, that can be separated from the liquid phase to allow disposal of the solids and liquids separately. In some embodiments, the resulting solids may be washed to remove residual liquid from the absorbing solution and to remove certain dissolvable chemicals from the solids. Washing of the solids may provide solids having a given chemical composition necessary for disposal or possible sale. For example, in some embodiments in which calcium carbonate is used, the blowdown stream will comprise calcium carbonate solids, which can be used in roadbed construction and in the manufacture of cement and concrete. It should be appreciated that the concentration of the catalyst in the blowdown stream will be relatively low since the concentration in the absorbing solution 218 is also relatively low. Therefore, disposal of the blowdown stream comprising a low concentration of catalyst should not present any particular disposal issues.

FIG. 2A illustrates a process comprising a wet electrostatic precipitator as a carbon dioxide absorber and related process equipment for implementing another embodiment of the present invention. This embodiment is similar to that shown in FIG. 2, except that a wet electrostatic precipitator 207 is used in the absorber 202 in place of the packed bed 206. One advantage of using a wet electrostatic precipitator for the removal of carbon dioxide is that particulate (in particular that fraction of particulate having a size smaller than approximately 1 micron in size) and sulfur trioxide may also be removed. It is well known in the industry that particulate of this very small size is not removed in the particulate collection device 106 or the sulfur dioxide absorber 110. Because the particulate of this very small size is well known to be a major contributor to the problem of impacted regional atmospheric visibility, it is desirable to remove as much of it as possible. It is also well known in the industry that sulfur trioxide is not removed in the particulate collection device 106 or the sulfur dioxide absorber 110, and as a result is exhausted through the stack 118. Because sulfur trioxide reacts with water vapor in the atmosphere to produce sulfuric acid mist, and since this mist deposits in regions around the power plant, removal of sulfur trioxide from the flue gas is receiving increasing regulatory scrutiny. Therefore, it is desirable to remove sulfur trioxide from the flue gas. Further, it is important to note that many power plants have added or are required to add a selective catalytic reduction (SCR) system to the boiler for reduction of nitrogen oxide emissions. However, the catalyst used in SCR systems also catalyzes the oxidation of the sulfur dioxide present in the flue gas to sulfur trioxide, thereby increasing the concentration of the latter in the flue gas and the need to remove the sulfur trioxide from the flue gas.

A wet electrostatic precipitator uses a high voltage, direct current field of between 45,000 volts to 60,000 volts applied to discharge electrodes to ionize the flue gas, producing a corona around these electrodes. Each discharge electrode is enclosed within a tubular collection electrode (or between parallel plate type collection electrodes) that is connected to ground. The ions produced migrate to the collection electrodes and in the process come into contact with pollutants, including particulate and sulfur trioxide, imparting a charge to these and causing them to migrate to the collecting electrodes. These collected pollutants are flushed from the electrodes by a film of water, effectively removing them from the flue gas.

In addition, a wet electrostatic precipitator may be used to oxidize and absorb vaporous mercury in the flue gas. In this case, it is believed that the corona (if created by oscillating the power supply to the electrodes between an alternating current and a direct current) will oxidize the elemental form of mercury (which is difficult to remove in any of the collection devices described) to an oxidized form, which is known to be readily removed. Therefore, the use of a wet electrostatic precipitator may provide the advantage of removing carbon dioxide, particulate, sulfur trioxides, and mercury from a flue gas stream.

In the process 200A shown in FIG. 2A, the absorber 202 and all of the related equipment is the same as that shown in FIG. 2, except, as noted, that the absorber 202 comprises a wet electrostatic precipitator 207 instead of a packed bed 206. In this case the absorbing solution 218 is distributed over the top of the wet electrostatic precipitator 207, and carbon dioxide is absorbed as the absorbing solution 218 travels through the wet electrostatic precipitator 207.

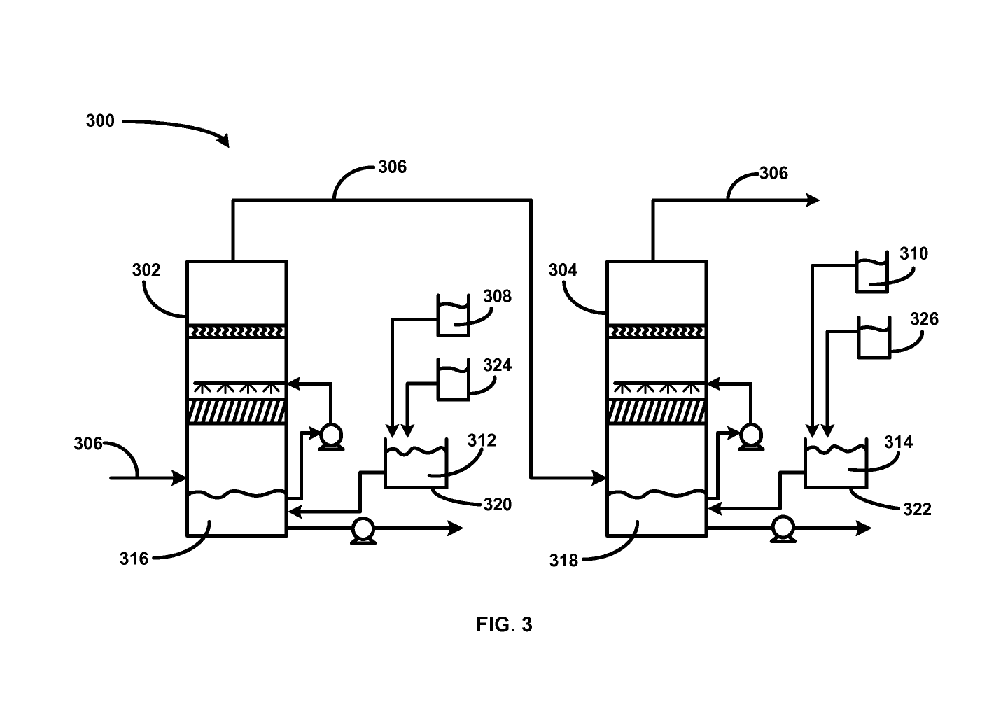

FIG. 3 illustrates a series of carbon dioxide absorbers and related process equipment for implementing another embodiment of the present invention. In this process 300, two carbon dioxide absorbers 302, 304, shown as packed bed absorbers, are used in series to remove carbon dioxide in two stages from a gas stream 306. In this embodiment, the gas stream 306 comprising carbon dioxide enters the first packed bed absorber 302, where a portion of the carbon dioxide is removed from the gas stream 306. Upon exiting the first packed bed absorber 302, the gas stream 306 is passed to the second absorber 304 where an additional portion of the carbon dioxide is removed from the gas stream 306.

Each of the packed bed absorbers 302, 304 are similar to that described in connection with FIG. 2. Optionally, as shown in FIG. 2, gas may be injected below each of the packed beds in each of the packed bed absorbers 302, 304. In addition, the operation of each of the packed bed absorbers 302, 304 is similar to that described in connection with FIG. 2, including the optional use of a catalyst. Further, it should be appreciated that any type of gas/liquid contactor may be substituted for one or both of the packed bed absorbers 302, 304 shown in FIG. 3.

One advantage of using a series of carbon dioxide absorbers is the ability to increase the amount of carbon dioxide removal. For example, if greater than 90%, or greater than 95%, or greater than 99% carbon dioxide removal is desired, the use of two carbon dioxide absorbers in series may be used to obtain such high removal percentages. In addition, the reagent used in each carbon dioxide absorber can be the same or different by using the same or different alkaline component. For example, in one embodiment the alkaline component 308 for the first packed bed absorber 302 may be calcium hydroxide, and the alkaline component 310 for the second packed bed absorber 304 may be sodium hydroxide. In this case, the reagents 312, 314 and the corresponding absorption solutions 316, 318 would have different compositions. This particular combination may be used when significantly high carbon dioxide removal percentages are desired. Alternatively, the alkaline components 308, 310 for use in each packed bed absorber 302, 304 may be the same (e.g., both may be sodium hydroxide or both may be calcium hydroxide), thereby giving the reagents 312, 314 and the absorption solutions 316, 318 the same composition, noting, however, that the quantity of carbon dioxide removal in each packed bed absorber 302, 304 may also affect the composition of the absorption solutions 316, 318.

As noted, a catalyst may be used in both of the packed bed absorbers 302, 304 or in one absorber only. As shown in FIG. 3, each packed bed absorber 302, 304 can be configured to add catalyst to the reagent feed tanks 320, 322 using chemical feed tanks 324, 326. Of course, the other options for adding the catalyst described above in connection with FIG. 2 are equally applicable here. If using a catalyst in both packed bed absorbers, 302, 304, the specific catalyst selected for use may be the same or different in each packed bed absorber 302, 304. Further, different catalysts may be used with different reagents or alkaline components. For example, a given catalyst may be used with calcium hydroxide as the alkaline component in the first packed bed absorber 302 and either that same catalyst or a different catalyst may be used with sodium hydroxide as the alkaline component in the second packed bed absorber 304. Alternatively, the same catalyst and the same alkaline component may be used in both packed bed absorber 302, 304, or all four of these components may be different. In other words, any combination of alkaline components and reagents may be used with any of the catalysts or combination of catalysts, and any of these combinations may be used in the first or second carbon dioxide absorber.

A further advantage of using two carbon dioxide absorbers is that the first absorber may be used to remove any residual sulfur dioxide from a gas stream prior to removing carbon dioxide. For example, a sulfur dioxide absorber may be used to remove sulfur dioxide from a flue gas stream generated by a coal-fired power plant. However, if that sulfur dioxide absorber does not remove a sufficient amount of sulfur dioxide, a dedicated and separate section of the first carbon dioxide absorber may be used to remove additional sulfur dioxide, with the remainder of the absorber removing a portion of the carbon dioxide. The remaining carbon dioxide desired to be removed from the flue gas can be removed in the second carbon dioxide absorber. In this case, it should be appreciated that the alkaline component of the reagent in the first carbon dioxide absorber is used for both sulfur dioxide and carbon dioxide removal in the separate sections of the first absorber.

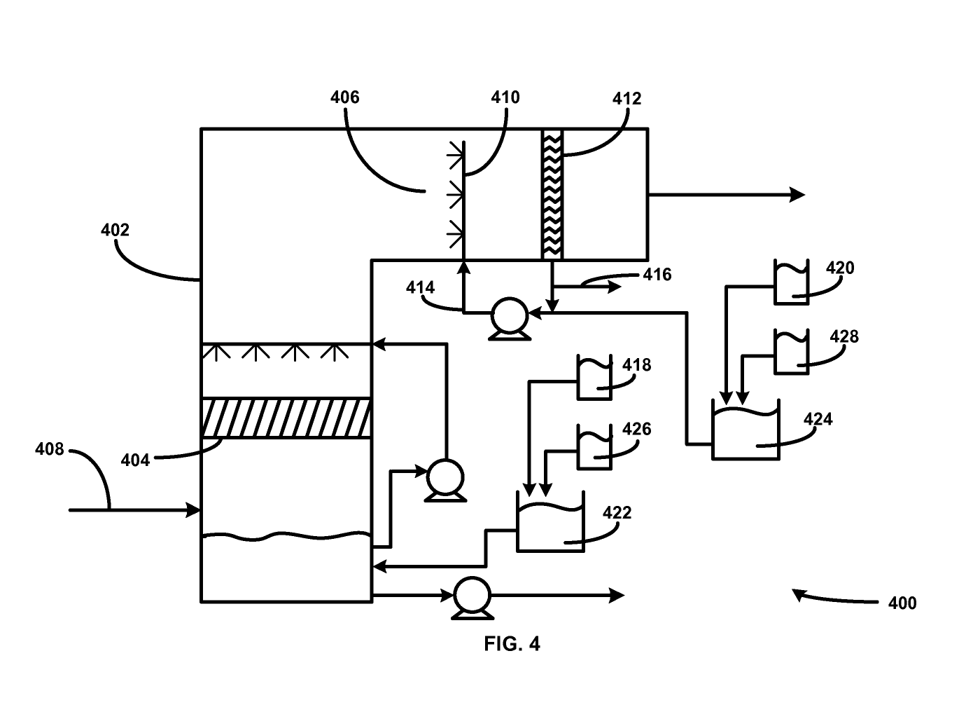

FIG. 4 illustrates a carbon dioxide absorber having a vertical stage and a horizontal stage for implementing another embodiment of the present invention. In this process 400, instead of having two separate carbon dioxide absorbers, a single carbon dioxide absorber 402 having two separate absorption sections 404, 406 is used to provide two stages for carbon dioxide removal. In this case, a gas stream 408 comprising carbon dioxide enters the carbon dioxide absorber 402 and passes through the first or upstream absorption section 404 where a portion of the carbon dioxide is removed. The gas stream 408 then passes through the second or downstream absorption section 406 where an additional portion of the carbon dioxide is removed.

In one embodiment, the first or upstream absorption section 404 comprises a packed bed and the second or downstream absorption section 406 simply comprises an area in which absorption solution is sprayed into the gas stream through a bank of nozzles 410. Optionally, as shown in FIG. 2, gas may be injected below the packed bed of the first absorption section 404. The absorption solution in the second absorption section 406 is collected by a mist eliminator 412 and recycled to the bank of nozzles 410 through recycle line 414, from which a discharge or blowdown stream 416 may be taken. It should be appreciated, however, that any type of gas/liquid contact equipment can be used in each of these sections, as well as a combination of one or more gas/liquid contactors in each section. For example, the first absorption section 404 may be a spray tower and the second absorption section may be a packed bed, a wet electrostatic precipitator, or a combination of a packed bed and a wet electrostatic precipitator. Similar to the use of two carbon dioxide absorbers described in connection with FIG. 3, each absorption section may use the same or different alkaline component 418, 420 in the reagent 422, 424. Also, catalysts 426, 428 may be added separately to either of the absorption sections 404, 406 with the reagents 422, 424 or by any other means as described above in connection with FIG. 2. Further, all of the various combinations of catalyst and alkaline components as described above in connection with FIG. 3 may be used as well for each absorption section 404, 406. Also, similar to the operation of the process 300 described in FIG. 3, this process 400 also allows for the combined removal of sulfur dioxide and carbon dioxide in the first stage or first absorption section 404. In most other respects, the operation of this carbon dioxide absorber 402, including recirculation of the absorption solution and blowdown operations, is similar to those described in connection with FIGS. 2 and 3.

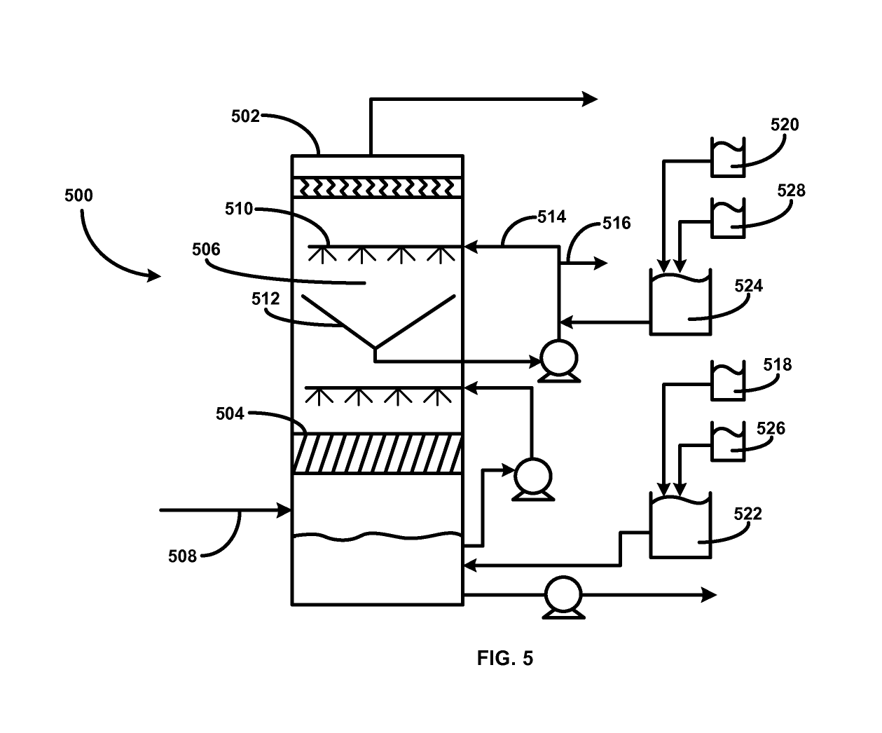

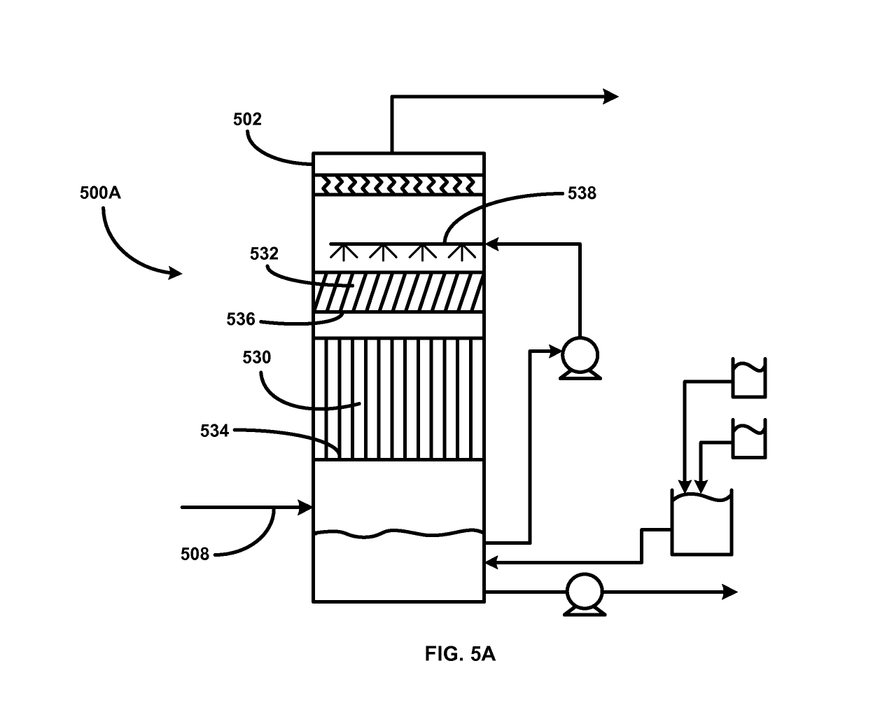

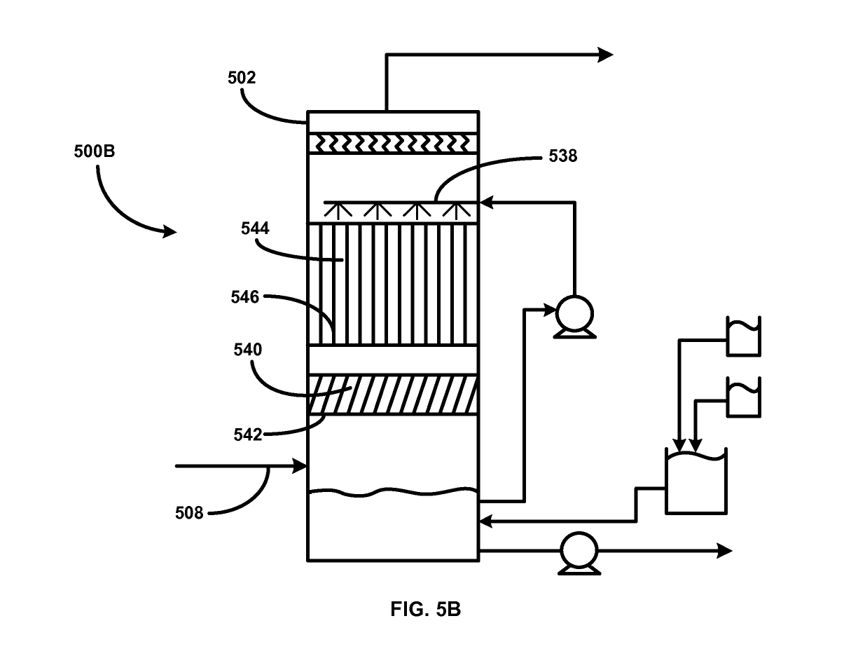

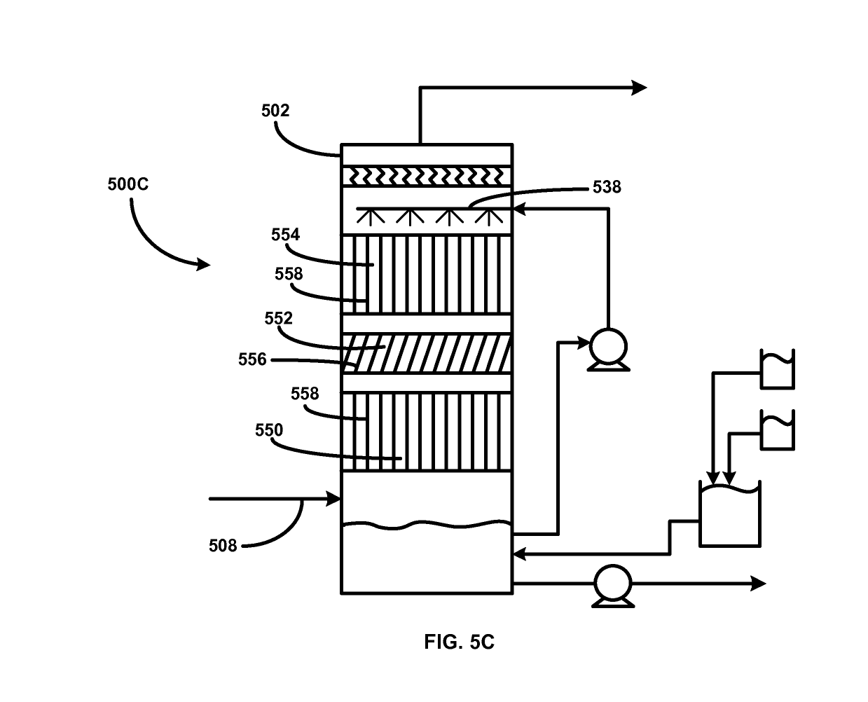

FIG. 5 illustrates a carbon dioxide absorber with two stages for implementing another embodiment of the present invention. In this process 500, the carbon dioxide absorber 502 and related process equipment is similar to that shown in FIG. 2 with the exception that the carbon dioxide absorber 502 comprises two absorption sections 504, 506. In this embodiment, contrary to that shown in FIG. 4, both absorption sections 504, 506 are designed for operation without a change in gas flow direction between the absorption sections 504, 506. In this case, a gas stream 508 comprising carbon dioxide enters the carbon dioxide absorber 502 and passes through the first or upstream absorption section 504 where a portion of the carbon dioxide is removed. The gas stream 508 then passes through the second or downstream absorption section 506 where an additional portion of the carbon dioxide is removed.

The first or upstream absorption section 504 is shown as a packed bed. Optionally, as shown in FIG. 2, gas may be injected below the packed bed of the first absorption section 504 to increase the amount of contact between the gas and the liquid in the packed bed. The second or downstream absorption section 506 comprises a spray area into which absorption solution is sprayed into the gas 508 from a bank of nozzles 510. The absorption solution in this section 506 is collected by a collection device 512 and recycled to the bank of nozzles 510 through recycle line 514, from which a discharge or blowdown stream 516 may be taken. It should be appreciated that a tank (not shown) may be necessary to hold the absorbing solution after it is collected and before it is recycled to the bank of nozzles 510. The collection device 512 may be any device capable of collecting the absorption solution or separating it from the gas stream, such as a funnel. It should be appreciated, however, that any type of gas/liquid contact equipment can be used in each of these sections and in any combination. For example, the first absorption section 504 may be a spray tower or a tray tower and the second absorption section 506 may be a packed bed, or both absorption sections may utilize the same type of gas/liquid contact equipment such as spray towers or sprays of absorbing solution or packed beds.

Similar to the use of two carbon dioxide absorbers described in connection with FIG. 3, each absorption section may use the same or different alkaline component 518, 520 in the reagent 522, 524. Also, catalysts 526, 528 may be added separately to either of the absorption sections 504, 506 with the reagents 522, 524 or by any other means as described above in connection with FIG. 2. Further, all of the various combinations of catalyst and alkaline components as described above in connection with FIG. 3 may be used as well for each absorption section 504, 506. However, it should be appreciated that the use of calcium hydroxide as the alkaline component may result in some scaling inside the carbon dioxide absorber 502. Therefore, if scaling is an issue during operation, it may be preferable to avoid the use of calcium hydroxide in the second absorption section 506. Also, similar to the operation of the process 300 described in FIG. 3, this process 500 also allows for the combined removal of sulfur dioxide and carbon dioxide in the first stage or first absorption section 504. In most other respects, the operation of this carbon dioxide absorber 402, including recirculation of the absorption solution and blowdown operations, is similar to those described in connection with FIGS. 2 and 3.

FIG. 5A illustrates another carbon dioxide absorber with two stages for implementing another embodiment of the present invention. In this process 500A, the carbon dioxide absorber 502 and related process equipment are similar to that shown in FIG. 2 with the exception that the carbon dioxide absorber comprises two absorption sections 530, 532. Similar to FIG. 5, the carbon dioxide absorber 502 and the two absorption sections 530, 532 are designed for operation without a change in the direction of gas flow. A gas stream 508 comprising carbon dioxide enters the carbon dioxide absorber 502 and passes through the first or upstream absorption section 530 where a portion of the carbon dioxide is removed. The gas stream 508 then passes through the second or downstream absorption section 532 where an additional portion of the carbon dioxide is removed.

In this particular embodiment, the first or upstream absorption section 530 comprises a wet electrostatic precipitator 534, and the second or downstream absorption section 532 comprises a packed bed 536. Optionally, as shown in FIG. 2, gas may be injected below the packed bed 536 of the second absorption section 532 to increase the amount of contact between the gas and the liquid in the packed bed 536.

During operation, the absorbing solution is pumped to a bank of nozzles 538 and distributed over the packed bed 536. The absorbing solution travels through the packed bed 536 and passes to the wet electrostatic precipitator 534. The absorbing solution then travels through the wet electrostatic precipitator 534. Accordingly, as the gas stream 508 passes through the wet electrostatic precipitator 534, a portion of the carbon dioxide in the gas stream 508 is removed by the absorbing solution passing through the wet electrostatic precipitator 534 in a counter-current manner. After exiting the wet electrostatic precipitator 534, the gas stream 508 passes through the packed bed 536, where an additional portion of carbon dioxide is removed from the gas stream 508. In this manner, the absorbing solution is only introduced into the carbon dioxide absorber at one location, namely downstream of the second absorption section 532.

Similar to the operation of the carbon dioxide absorber described in FIG. 2, any alkaline component or combination of alkaline components, with or without a catalyst or mixture of catalysts, may be used in this process 500A. Also, operation of this process 500A, including recirculation of the absorption solution and blowdown operations, is similar to that described in connection with FIG. 2.

FIG. 5B illustrates another carbon dioxide absorber with two stages for implementing another embodiment of the present invention. This process 500B is similar to that described in FIG. 5A, with the exception that the upstream absorption section 540 comprises a packed bed 542 and the downstream absorption section 544 comprises a wet electrostatic precipitator 546. Optionally, as shown in FIG. 2, gas may be injected below the packed bed 542 of the upstream absorption section 540 to increase the amount of contact between the gas and the liquid in the packed bed 542.

The operation of this configuration is similar to that described in FIG. 5A, wherein the absorbing solution is introduced at a single location in the carbon dioxide absorber 502 that is downstream of the downstream absorption section 544. The absorbing solution is pumped to a bank of nozzles 538 and passed to, in this case, the wet electrostatic precipitator 546. The absorbing solution travels through the wet electrostatic precipitator 546 and passes to the upstream absorption section 540 and the packed bed 542. The absorbing solution then travels through the packed bed 542. Accordingly, as the gas stream 508 passes through the packed bed 542, a portion of the carbon dioxide in the gas stream 508 is removed by the absorbing solution passing through the packed bed 542. After exiting the packed bed 542, the gas stream 508 passes through wet electrostatic precipitator 546, where an additional portion of carbon dioxide is removed from the gas stream 508. It should be appreciated that using a wet electrostatic precipitator as the final downstream absorption section may reduce the need for a mist eliminator further downstream depending upon the amount of mist in the gas stream that needs to be removed before the gas exits the carbon dioxide absorber 202.

Similar to the operation of the carbon dioxide absorber described in FIG. 2, any alkaline component or combination of alkaline components, with or without a catalyst or mixture of catalysts, may be used in this process 500B. Also, operation of this process 500B, including recirculation of the absorption solution and blowdown operations, is similar to that described in connection with FIG. 2.

FIG. 5C illustrates another carbon dioxide absorber with multiple stages for implementing another embodiment of the present invention. This process 500C is similar to those described in FIGS. 5A and 5B, with the exception that there are essentially three absorption sections 550, 552, 554 created by the use of a packed bed 556 positioned within a wet electrostatic precipitator 558. It should be appreciated that although the packed bed 556 is disposed between the two sections of the wet electrostatic precipitator 558, both of these sections are electrically connected such that they function as a single wet electrostatic precipitator. In other words, both sections are operated as a single wet electrostatic precipitator even though they are physically separated by the packed bed 556. Optionally, as shown in FIG. 2, gas may be injected below the packed bed 556 to increase the amount of contact between the gas and the liquid in the packed bed 556.

The operation of this configuration is similar to that described in FIGS. 5A and 5B, wherein the absorbing solution is introduced at a single location in the carbon dioxide absorber 502 that is downstream of the last absorption section 554. The absorbing solution is pumped to a bank of nozzles 538 and passed to the downstream portion of the wet electrostatic precipitator 558. The absorbing solution exits the downstream portion of the wet electrostatic precipitator 558 and passes through the packed bed 556 in the middle absorption section 552. The absorbing solution exits the packed bed 556 and passes to and through the upstream portion of the wet electrostatic precipitator 558.

Accordingly, as the gas stream 508 passes first through the upstream portion of the wet electrostatic precipitator 558, a portion of the carbon dioxide in the gas stream 508 is removed by the absorbing solution passing through that portion of the wet electrostatic precipitator 558 in the upstream absorption section 550. After exiting the upstream portion of the wet electrostatic precipitator 558, the gas stream 508 passes through the packed bed 556, where an additional portion of carbon dioxide is removed from the gas stream 508 in the middle absorption section 552. Finally, after exiting the packed bed 556, the gas stream 508 passes through the downstream portion of the wet electrostatic precipitator 558, where yet an additional portion of carbon dioxide is removed from the gas stream 508 in the final absorption section 554. It should be appreciated that using a wet electrostatic precipitator as the final downstream absorption section may reduce the need for a mist eliminator further downstream depending upon the amount of mist in the gas stream that needs to be removed before the gas exits the carbon dioxide absorber 202.

Similar to the operation of the carbon dioxide absorber described in FIG. 2, any alkaline component or combination of alkaline components, with or without a catalyst or mixture of catalysts, may be used in this process 500C. Also, operation of this process 500C, including recirculation of the absorption solution and blowdown operations, is similar to that described in connection with FIG. 2.

As described above in connection with FIG. 5C, it should be appreciated that a carbon dioxide absorber may have more than two absorption sections. For example, in another configuration with multiple absorption sections, the absorber may have multiple banks of spray nozzles that each delivers absorbing solution to different locations or positions within the absorber. In a vertically-oriented absorber, where the gas flow is from the bottom of the absorber to the top of the absorber, three or more banks of spray nozzles positioned at different heights along the absorber may be used. In this case, the area between each bank of spray nozzles and the area under the lowest bank of spray nozzles would each constitute an absorption section.

As noted above, the embodiments shown in FIGS. 2-5 have been described in the context of removing carbon dioxide from a flue gas generated by a coal-fired boiler. It should be appreciated that in using these various embodiments and others with gas streams that also comprise sulfur dioxide that may otherwise be absorbed in the carbon dioxide absorber, a sulfur dioxide absorber or flue gas desulfurization system as shown in FIG. 1 should be used upstream of the carbon dioxide absorber. It is important to remove the sulfur dioxide before attempting to remove the carbon dioxide with an alkaline absorbing solution, since otherwise the presence of a significant amount of sulfur dioxide or other acid gases may be preferentially absorbed before the carbon dioxide, thereby consuming a significant portion of the alkalinity of the absorbing solution. Even with a sulfur dioxide absorber in place, it may still be necessary to remove an additional portion of the residual sulfur dioxide or other acid gases that remain after passing through such a sulfur dioxide absorber. In these cases, a second sulfur dioxide absorber may be required downstream of the first sulfur dioxide absorber and upstream of the carbon dioxide absorber. Further, in those systems that produce gas streams with sulfur dioxide or other acid gases but do not use a sulfur dioxide or acid gas absorber, such an absorber may be needed upstream of the carbon dioxide absorber. In either case, the sulfur dioxide absorber is being used to remove a relatively small amount of sulfur dioxide, compared to, for example, a full-scale flue gas desulfurization system, and may be referred to as a sulfur dioxide polisher. Similarly, a generic acid gas absorber may also be used to simply remove a relatively small concentration of acid gas that may otherwise interfere with the carbon dioxide removal process.

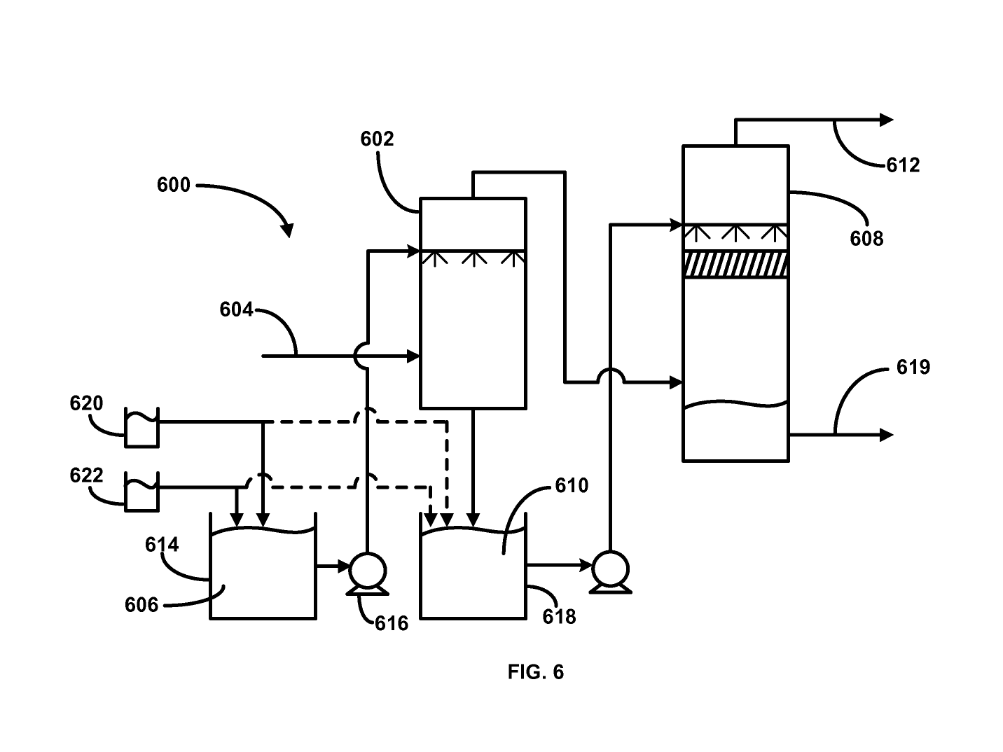

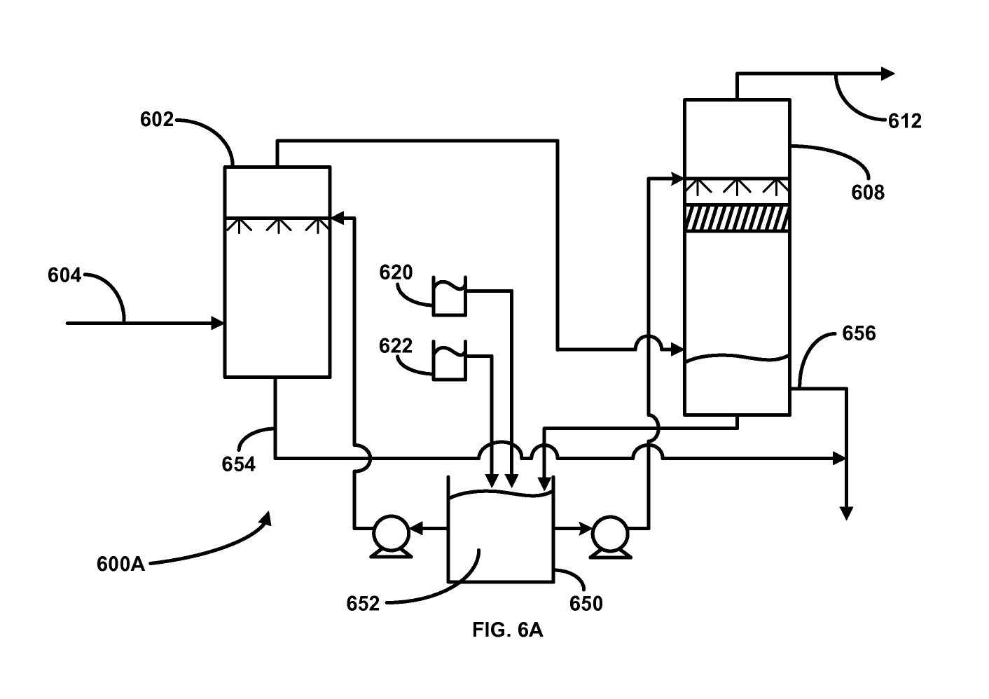

FIG. 6 illustrates a process for the removal of sulfur dioxide and carbon dioxide according to one embodiment of the present invention. As shown in the process 600, a sulfur dioxide absorber 602 receives a gas stream 604 that contains both sulfur dioxide and carbon dioxide. As noted, in some embodiments, this gas stream 602 may be a gas stream exiting from an upstream sulfur dioxide absorber or flue gas desulfurization system, in which case the sulfur dioxide absorber 600 shown in FIG. 6 may be used to remove additional sulfur dioxide, thereby polishing the gas stream prior to removing carbon dioxide. Alternatively, the gas stream 604 may be from a process that generates a relatively low concentration of sulfur dioxide or other acid gases.

The sulfur dioxide absorber 602 may be any type of gas/liquid contactor, such as those described above for the carbon dioxide absorbers. Further any configuration of gas flow relative to liquid flow may be used, as also described above for the carbon dioxide absorbers.

The gas stream 604 travels through the sulfur dioxide absorber 602 where it is contacted with a sulfur dioxide absorbing solution 606 to remove sulfur dioxide from the gas stream 604. The gas stream then passes from the sulfur dioxide absorber 602 to the carbon dioxide absorber 608, where it is contacted with another absorbing solution 610. The gas stream then passes from the carbon dioxide absorber 610 through a carbon dioxide absorber outlet duct 612 for discharge.

The absorbing solution 606 may be any alkaline solution capable of removing sulfur dioxide from the gas stream 604. The absorbing solution 606 is passed to the sulfur dioxide absorber 602 from a reagent tank 614 using a reagent feed pump 616. Since the sulfur dioxide absorber 602 is directed to use as a polisher, significantly high removal rates of sulfur dioxide can be achieved using a highly alkaline absorbing solution 606. Accordingly, the absorbing solution may comprise alkaline components such a sodium or calcium hydroxide. The concentration of the alkaline component in the absorbing solution 606 or its pH can be set depending upon the amount of sulfur dioxide removal desired. It should be appreciated that other acid gases may also be removed using this absorber 602, and other components may be added to the reagent feed tank 614 to assist in the removal of these acid gases.

The absorbing solution 606 passes from the sulfur dioxide absorber 602 to a reaction tank 618, which in this embodiment also serves as a reagent feed tank for the carbon dioxide absorber 608, as discussed further below. In this configuration, it should be appreciated that the absorbing solution 606 only passes through the sulfur dioxide absorber one time. Also, it should be appreciated that the reaction tank 618 does not have to serve as the reagent feed tank for the carbon dioxide absorber 608, since a separate reagent feed tank, as described above in connection with any of the carbon dioxide absorbers also described herein, can be used. Further, the reaction tank 618 may also be integral to the sulfur dioxide absorber.

The carbon dioxide absorber 608 may be any of the carbon dioxide absorbers described herein and may be operated in any of the same manners described herein. In the process 600, however, since the reaction tank 618 for the sulfur dioxide absorber acts as a reagent feed tank for the carbon dioxide absorber 608, the alkaline components for carbon dioxide absorption may be added to either the reagent feed tank 614 or the reaction tank 618 for the sulfur dioxide absorber 602. In some embodiments, the alkaline component for sulfur dioxide removal may be the same as the alkaline component for carbon dioxide removal, and accordingly may be any of the alkaline components described herein for carbon dioxide removal. It should be appreciated, however, to the extent that the reaction tank 618 also serves as a reagent feed tank for the carbon dioxide absorber 608, that the absorbing solution 610 used in the carbon dioxide absorber 608 will also contain the reaction products from the absorption of sulfur dioxide. Therefore, the composition of the blowdown 619 from the carbon dioxide absorber 608 will be different than those embodiments where only carbon dioxide is removed using a given absorbing solution.

The alkaline component for either sulfur dioxide removal or carbon dioxide removal may be added to either the reagent feed tank 614 or the reaction tank 618 (as shown by the dashed lines) for the sulfur dioxide absorber 602 or both from chemical feed tanks 620, 622. In addition, a catalyst for carbon dioxide removal as described herein may also be added via one of the chemical feed tanks 620, 622 to either the reagent feed tank 614 or the reaction tank 618 for the sulfur dioxide absorber 602 or both.

FIG. 6A illustrates another process for the removal of sulfur dioxide and carbon dioxide according to another embodiment of the present invention. This process 600A is similar to that shown in FIG. 6, however, with several exceptions. Instead of having a separate reagent feed tank and reaction tank for the sulfur dioxide absorber, there is a single reagent feed tank 650 from which an absorbing solution 652 is fed to the sulfur dioxide absorber 602. After passing through the sulfur dioxide scrubber 602, the absorbing solution is discharged from the system through a blowdown line 654.

The reagent feed tank 650 also serves as the reagent feed tank for the carbon dioxide absorber 608. In addition, this reagent feed tank 650 also serves as the reaction tank for the carbon dioxide absorber 608 because it collects the absorbing solution 652 after passing through the carbon dioxide absorber 608. Otherwise, the carbon dioxide absorber 608 may be constructed and operated in the same fashion as those carbon dioxide absorbers described previously. A blowdown stream from the carbon dioxide absorber 608 is discharged through blowdown stream line 656 and combined with the blowdown stream 654 from the sulfur dioxide absorber. As discussed in connection with FIG. 6, chemical feed tanks 620, 622 may be used to feed one or more alkaline components to the reagent feed tank 650 and to add additional chemicals, such as a catalyst for carbon dioxide removal.

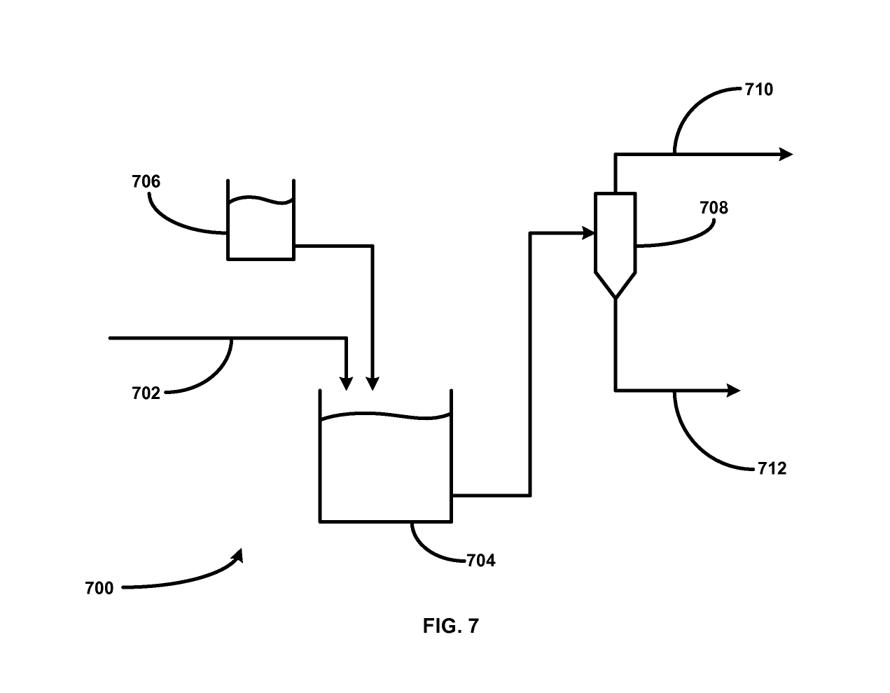

FIG. 7 illustrates a process for regenerating reagent for use in an embodiment of the present invention. In this process 700, a discharge or blowdown stream 702 comprising a portion of the absorption solution from any of the foregoing carbon dioxide absorbers or from any one of the stages from those carbon dioxide absorbers having two stages in which the alkaline component comprises at least sodium hydroxide is directed to a regeneration tank 704. A solution comprising calcium hydroxide is held in a feed tank 706 and is fed to the regeneration tank 704, where it is mixed and reacted with the discharge stream 702. As noted above, in those embodiments in which the alkaline component of the reagent is sodium hydroxide, the absorption solution will contain sodium carbonate as a result of the absorption of carbon dioxide. This sodium carbonate is reacted with the calcium hydroxide in the regeneration tank 704 to regenerate the alkaline component sodium hydroxide and to produce calcium carbonate solids according to the following equation:

Na₂CO₃⁼+Ca(OH)₂→2NaOH+CaCO₃(s) Eq. (7)

The reaction products of sodium hydroxide and calcium carbonate solids in the regeneration tank 704 are passed to a liquid/solid separator 708, such as a hydrocyclone or other device that can reasonably separate solids and liquids. The liquid/solid separator 708 produces a liquid stream 710 comprising sodium hydroxide that tends to stay in solution, and a solids-rich stream 712 comprising calcium carbonate solids that do not dissolve easily into the liquid phase and, therefore, can be easily separated in the separator 708 from the sodium hydroxide. The liquid stream 710 may be recycled back to either a chemical feed tank that holds the alkaline component or to the reagent tank of any of the foregoing carbon dioxide absorber processes. This process 700 is particularly useful in those situations where the discharge or blowdown stream cannot be easily disposed of, since the resulting solids-rich stream 712 comprising calcium carbonate solids can be easily disposed of. In addition, process economics are further improved by reclaiming the sodium hydroxide.

Further, as discussed above, the calcium carbonate solids precipitated in this regeneration process, which comprise basically the captured carbon dioxide in a stable solid form, have been found to be a relatively pure form of Precipitated Calcium Carbonate (PCC), a high value chemical used in producing expensive grades of paper, paints, latex, and other products. Such PCC has a discrete particle size distribution and crystal structure. Unlike naturally occurring limestone, which is typically ground into small, non-uniform particles, the precipitated calcium carbonate would contain less impurities like feldspar, other silicaceous materials, and heavy metals and also exhibit a more uniform size. In addition, the precipitated calcium carbonate may have certain crystal structures and shapes, such as needles, cubes, rhombohedrons, and prisms, that have desirable physical properties, including powder density and surface area, allowing these crystals to perform better than those in ground calcium carbonate. Calcium carbonate solids produced by this regeneration process at the laboratory-scale were analyzed and had the following properties: Brightness (MT): Rx 96.1%, Ry 95.5%, Rz 95.1%; yellowness index: 1.1, R457 TAPPI 94.7%, Hunter L 97.7%, Hunter a 0.73%, Hunter b 0.20%; Sedigraph: 55% less than 1 micrometer, 46% less than 0.5 micrometers, and 30% less than 0.2 micrometers; surface area (BET): 16.3 square meters per gram. In removing carbon dioxide from a flue gas generated by a coal-fired boiler, it should be noted that the properties of the precipitated calcium carbonate may vary depending on the type of boiler, the composition of the coal used, and other factors. The current industrial uses of precipitated calcium carbonate are varied and numerous, including, for example, use in the pulp processing steps in paper making, paints, latexes, and in the production of consumer pills.

The production of PCC from the capture of carbon dioxide is a significant process development as it greatly enhances the overall economics of this process. The value of such precipitated calcium carbonate is on the order of $300-$400 per ton. Also, by calcining a portion of the precipitated calcium carbonate, most or all of the calcium hydroxide required in the regeneration system can be produced, thereby partially or completely eliminating the need for the purchase of calcium oxide or calcium hydroxide from an external supplier, which improves the economics of the carbon dioxide capture system.

These solids may also be used in roadbed construction and in the manufacture of cement and concrete. For example, the precipitated calcium carbonate may be used as a replacement for Portland cement. Portland cement has historically been a key ingredient, along with sand and aggregate, in the manufacture of concrete, a globally used material. Concrete is normally manufactured by mixing Portland cement, sand, and aggregate in a specific ratio of one part, two parts, and three parts, respectively, by volume. Cement has been made using calcium carbonate solids produced by the regeneration process described above at both the power plant-scale and the laboratory-scale as a substitute for a portion of the Portland cement. There are several advantages of using these solids as a substitute for Portland cement. First, the amount of Portland cement required to manufacture concrete can be reduced. Also, flyash, if captured by the processes described above, can be additionally blended with the precipitated calcium carbonate to further reduce the amount of Portland cement required for the manufacture of concrete. These reductions in the amount of Portland cement will represent a potentially significant reduction of carbon dioxide emissions that are normally produced during the manufacture of Portland cement, in addition to the carbon dioxide emissions captured by the processes described above. This is a significant process development as it would enable the source of the carbon dioxide emissions to get valuable “carbon credits” by reducing the quantity of Portland cement manufactured, in addition to the credits derived from capturing carbon dioxide in its own plant. Further, the concrete produced by the use of these solids represents a potential revenue stream, partially offsetting the cost of installing and operating the carbon dioxide capture system.

It should be appreciated that potassium hydroxide may be used instead of calcium hydroxide in the feed tank 706. In this case, the potassium hydroxide would react with the sodium carbonate to regenerate sodium hydroxide as follows:

Na₂CO₃+2KOH→2NaOH+K₂CO₃ Eq. (8)

Since potassium hydroxide is produced by electrolysis of potassium chloride ore, there is no carbon dioxide produced or released into the atmosphere during its production. Accordingly, the use of potassium hydroxide in the present invention provides a process that, even when taking into account the reagents used, avoids carbon dioxide emissions. Further, the potassium carbonate produced by this regeneration reaction (Eq. 8) will be returned to the carbon dioxide absorbers via the liquid-rich stream 710, which is beneficial because it is believed that a solution comprising potassium hydroxide may have a greater affinity for the absorption of carbon dioxide than for sulfur dioxide. The potassium hydroxide in the absorbing solution will react with absorbed carbon dioxide as follows:

K₂CO₃(l)+CO₂(g)+H₂O(l)→2K⁺+2HCO₃⁻(l) Eq. (9)

By preferentially absorbing carbon dioxide, less sulfur dioxide would be absorbed from the flue gas, to the extent that sulfur dioxide is present, which may avoid at least some reduction in the capacity of the absorbing solution to absorb carbon dioxide. A portion or all of this potassium carbonate stream may also be saleable in the fertilizer industry, for example, as a soil amendment. This stream may be either sold in its current form or water may be evaporated to concentrate the potassium ions and minimize transportation costs. For example, this stream comprising potassium ions may be sent to an evaporation pond where the water is evaporated and the remaining solids are scraped together and sold.

In those embodiments where there are either two carbon dioxide absorbers or two separate absorption sections and where one of the absorbers or sections utilizes sodium hydroxide and where the other absorber or component utilizes calcium hydroxide as the alkaline component, the blowdown streams preferably would not be mixed so that the sodium-based stream could be used in the regeneration process to regenerate sodium hydroxide. Alternatively, if both absorbers or both absorption sections utilize sodium hydroxide as the alkaline component, then the blowdown streams from each could be combined and treated together in the regeneration process.

It should be appreciated that in any of these embodiments in which the alkaline component is regenerated, a certain amount of the alkaline component may still need to be added to the process, as some of the alkaline component may be lost through normal operation. For example, depending upon the overall water balance, some water containing the alkaline component may need to be discharged, which would result in a loss of the alkaline component necessitating the addition of fresh alkaline component to the system.

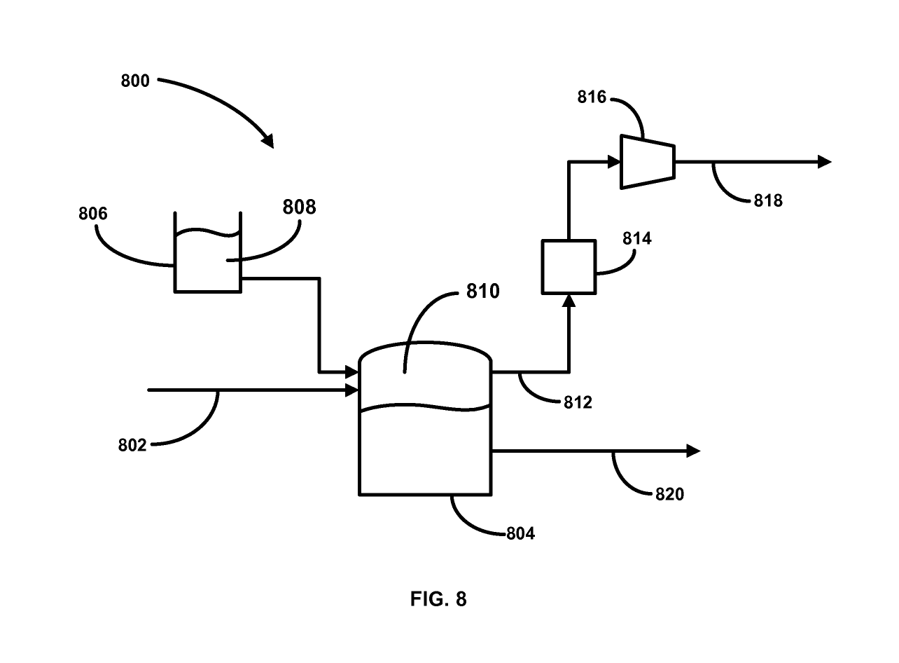

FIG. 8 illustrates a process for producing gaseous carbon dioxide according to one embodiment of the present invention. In this process 800, a discharge or blowdown stream 802 comprising a portion of the absorption solution from any of the foregoing carbon dioxide absorbers or from any one of the stages from those carbon dioxide absorbers having two stages in which the alkaline component comprises at least sodium hydroxide is directed to a covered tank 804. A feed tank 806 is configured to hold an acidic solution 808 capable of reducing the pH of the blowdown stream. In some embodiments, the acid may be an inorganic acid, such as sulfuric acid. The concentration of the acidic solution 808 may be adjusted depending upon the amount of acid required to reduce the pH of the blowdown stream 802 to the desired pH, taking into account water balances.

Upon addition of the acidic solution 808 to the covered tank 804, the pH of the blowdown stream 802 is reduced to off-gas carbon dioxide. In some embodiments, the pH is reduced to approximately 3.0 or lower, and in other embodiments, the pH is reduced to approximately 2.0 or lower. The resulting gaseous carbon dioxide is collected in the upper region 810 of the closed tank 804 and is passed through a gas discharge line 812 to a moisture knock-out device 814 to reduce the moisture content in the carbon dioxide gas stream. The moisture knock-out device 814 may be any device known in the art capable of reducing the water or moisture content of a gas stream, including a cyclonic separator or dessicant chamber. The carbon dioxide gas stream is then passed to a compressor 816 that increases the gas stream's pressure to produce a saleable carbon dioxide gas stream 818. For example, the carbon dioxide gas produced may be used in enhanced oil recovery or other industrial processes.

The production of gaseous carbon dioxide in the closed tank 804 will result in the production of liquid sulfite having a cation corresponding to that of the alkaline component used in the carbon dioxide absorber. For example, if sodium hydroxide is used as the alkaline component, liquid phase sodium sulfite will be produced in the closed tank 804 upon the reduction of the pH and off-gassing of the carbon dioxide. Similarly, if potassium hydroxide is used as the alkaline component, liquid phase potassium sulfite will be produced in the closed tank 804. This liquid sulfite is passed through a liquid discharge line 820, which may be subsequently treated to recover the sulfite or reused.

It should be appreciated that the various processes and absorbers described above may be used to produce both gaseous carbon dioxide and calcium carbonate solids from the same system. A computer system can be used to control the operation of the carbon dioxide absorber as well as a regeneration system and a system operator could control the system to produce a desired ratio of carbon dioxide gas to calcium carbonate solids.

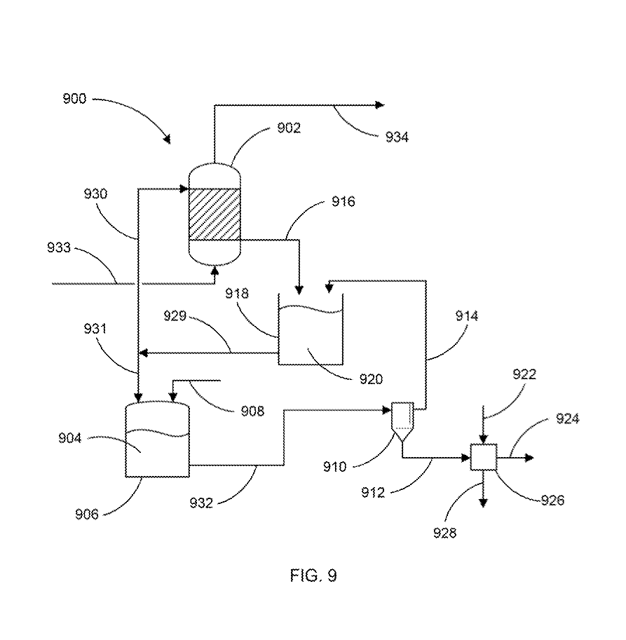

FIG. 9 illustrates a process for removing sulfur dioxide and chloride from a gas stream upstream of a carbon dioxide absorber to produce salable calcium chloride according to one embodiment of the present invention. As noted above, it may be necessary to remove sulfur dioxide or other acid gases prior to passing the gas stream to the carbon dioxide absorber. In those systems with a sulfur dioxide absorber, a second sulfur dioxide absorber may be required downstream of the first sulfur dioxide absorber and upstream of the carbon dioxide absorber. In those systems that produce gas streams with sulfur dioxide or other acid gases but do not use a sulfur dioxide or acid gas absorber, such an absorber may be needed upstream of the carbon dioxide absorber. In either case, the sulfur dioxide absorber is being used to remove a relatively small amount of sulfur dioxide, compared to, for example, a full-scale flue gas desulfurization system, and may be referred to as a sulfur dioxide polisher.

In this embodiment 900, this relatively small amount of sulfur dioxide, or a significant portion thereof, is removed from the flue gas 933 in a separate primary stage 902, referred to as a “pre-loop” absorber, along with a portion of the carbon dioxide from the flue gas 933. It should be appreciated that the pre-loop absorber may be an absorber separated from the carbon dioxide absorber or may alternatively be a separate absorption section that is integral to the carbon dioxide absorber. In the latter case, the pre-loop absorption section would be upstream of the main carbon dioxide absorption section.

The flue gas 933 is passed through the pre-loop absorber 902 and is contacted with an alkaline liquid stream or slurry 920, generally referred to as an absorbing solution. The absorbing solution 920 is fed through a feed line 929, 930 to the pre-loop absorber 902 from a reaction tank 918 and after passing through the pre-loop absorber 902 is collected in the reaction tank 918.

Importantly, in gas streams containing hydrogen chloride, including, for example, some power plants that produce flue gas containing a relatively high level of hydrogen chloride, that hydrogen chloride can also be removed using the absorbing solution 920 in the pre-loop absorber 902 to produce dissolved chlorides in the absorbing solution 920. In some embodiments, the absorbing solution 920 comprises an alkaline slurry comprising a calcium-based alkaline reagent, such as calcium hydroxide, that results in the production of calcium chloride upon the absorption of the hydrogen chloride from the flue gas. In this embodiment, a portion of the absorbing solution 920 containing calcium chloride is passed from the reaction tank 918 through a line 931 to a holding tank 906 to which fresh alkaline reagent 908 is added. A stream 932 from the holding tank 906 is passed to a liquid/solid separator 910, such as a hydroclone, to separate the calcium chloride and other solids 912, including small quantities of relatively insoluble calcium sulfite and calcium sulfate, from the liquid phase 914, which is primarily dissolved calcium chloride and which is returned to the reaction tank 918. The remaining calcium chloride solids 912 not separated from the calcium sulfite and calcium sulfate solids in the liquid/solid separator 910 are passed to a second separator 926, such as a centrifuge to which a settling aid 922 may be added. In the second separator 926, the calcium chloride solids are separated from the other remaining solids. A salable calcium chloride product 924 is discharged from the second separator 926 along with settled solids of calcium sulfite and calcium sulfate 928, which are combined later with similar waste solids calcium sulfite and calcium sulfate from the sulfur dioxide absorber 110.

It should be appreciated that the production of calcium chloride is an important development as power plants can sell this chemical for use, for example, in suppression of road dust and highway freeze protection, thereby obtaining valuable emission credits for reduction of particulate matter and also replacing purchased commercial calcium chloride.

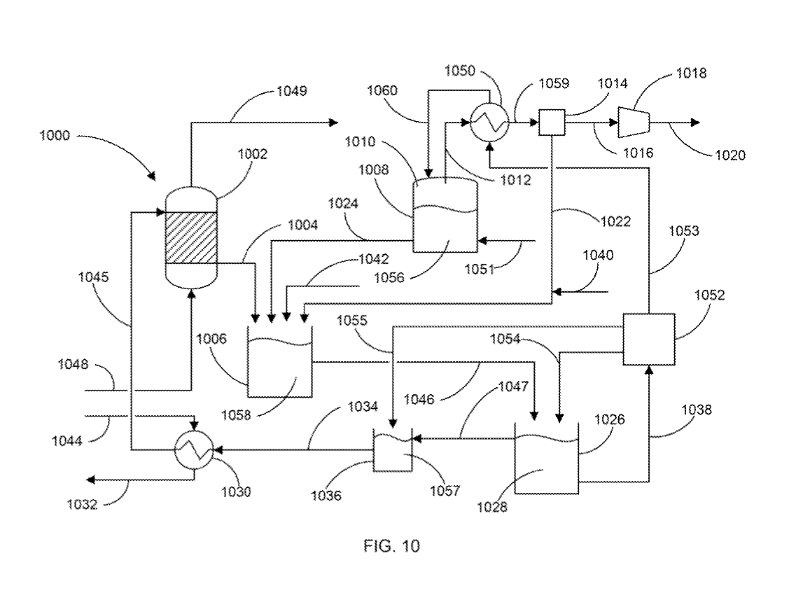

FIG. 10 illustrates another process for producing gaseous carbon dioxide according to one embodiment of the present invention. In this process 1000, a flue gas 1048 is passed through a carbon dioxide absorber 1002 and contacted with an absorption solution 1045. It should be appreciated that the carbon dioxide absorber 1002 may be any of those previously described. In addition, the absorption solution 1045 may be any of those described in connection with any of the foregoing carbon dioxide absorbers or from any one of the stages from those carbon dioxide absorbers having two stages in which the alkaline component comprises at least sodium bicarbonate and sodium carbonate. A discharge or blowdown stream 1004 from the carbon dioxide absorber 1002 is discharged into a precipitation tank 1006 comprising a portion of the absorption solution 1045. As explained below, reclaimed sodium carbonate 1024 from an off-gas reactor 1008 is added to the precipitation tank contents 1058 to supersaturate the sodium bicarbonate therein, which is then precipitated. The vapor space above the liquid level in the precipitation tank 1006 is maintained at a selected pressure to enhance the function of the tank. The slurry of sodium carbonate and precipitated sodium bicarbonate solids 1046 is then discharged to a settling tank 1026, where the sodium bicarbonate solids settle while the sodium carbonate remains in solution, thereby achieving a degree of separation between the dissolved sodium carbonate and the precipitated sodium bicarbonate. The precipitated sodium bicarbonate 1038 is discharged from the bottom of the settling tank 1026 and then dewatered using dewatering equipment 1052, such as a combination of hydroclones and a vacuum filter to create a dewatered precipitated sodium bicarbonate 1053 that is passed to a cooler 1050 where it is heated, as described below. The heated contents 1060 are then passed to the covered off-gas reactor 1008 along with any remaining sodium carbonate. The covered off-gas reactor 1008 is heated to raise the temperature of the solution 1056 in the tank 1008 to approximately 210° F. or higher, which can be done by any method known in the art, to decompose the sodium bicarbonate. The dewatering step in the hydroclones and vacuum filter 1052 reduces the amount of thermal energy required in the next step, as any water present with the sodium bicarbonate must first be evaporated before the sodium bicarbonate can be decomposed in the off-gas reactor 1008. In some embodiments, waste or other steam, such as the steam from the low pressure or other turbine stage of the steam turbine or from another part of a power plant, can be fed to steam coils installed along the height of the off-gas reactor 1008, or waste steam can be directly injected into the off-gas reactor 1008 and through direct contact with the solution raise its temperature to approximately 210° F. or higher. It should be noted that the use of waste steam to heat the off-gas reactor 1008 can enhance the overall economics of this process. Liquid 1055, 1054 obtained from the dewatering step can be passed to a tank 1036 (described further below) or recycled back to the settling tank 1026.

Upon addition of heat to the off-gas reactor 1008, the temperature of the contents 1056 is increased to the desired value causing the carbon dioxide in the solution to off-gas. The resulting gaseous carbon dioxide is collected in the upper region 1010 of the off-gas reactor 1008 and the collected carbon dioxide 1012 is passed to the cooler 1050, which cools the hot carbon dioxide and transfers the recovered heat to the dewatered slurry passing from the hydroclones and vacuum filter 1053. The resulting heated dewatered slurry 1060 is then discharged to the off-gas reactor 1008. The cooled carbon dioxide stream 1059 is then discharged to a moisture knock-out device 1014 to reduce the moisture content in the carbon dioxide gas stream 1059. The moisture knock-out device 1014 may be any device known in the art capable of reducing the water or moisture content of a gas stream, including a cyclonic separator or dessicant chamber. The carbon dioxide gas stream having reduced moisture 1016 is then passed to a compressor 1018 that increases the gas stream's pressure to produce a saleable carbon dioxide gas stream 1020. For example, the carbon dioxide gas produced may be used in enhanced oil recovery, by further compression, or in other industrial processes. Moisture 1022 recovered in the moisture knock-out device 1014 may be passed to the precipitation tank 1006. Additional water 1049, if needed, can be added to this moisture stream 1022.

The production of gaseous carbon dioxide in the off-gas reactor 1008 will result in the production of, or thermal regeneration of, liquid sodium carbonate from the sodium bicarbonate in the absorbing solution. The sodium carbonate solution 1024 is passed to the precipitation tank 1006.

The liquid 1047 from the upper portion of the settling tank 1026 is primarily sodium carbonate and is stored in a tank 1036 as reagent 1057 to be recycled back through a cooler 1030 (which is cooled by plant water 1044, resulting in heated water 1032 for use in the plant) to the absorber 1002 for use in capturing additional carbon dioxide. In some embodiments, virtually all the carbon dioxide captured in the absorbing solution is released in the off-gas reactor 1008, and all (up to and including 99.97%) of the sodium bicarbonate in the absorbing solution passed to the off-gas reactor 1008 is converted to sodium carbonate for re-use (resulting in up to and including 99.97% recovery of the sodium carbonate). This means that the starter batch of sodium reagent is almost completely recovered after completion of the absorption-regeneration cycle, requiring little additional (as in make-up sodium carbonate stream 1042) replenishment of sodium to the system. This is a significant development as it greatly reduces the operating cost and enhances the cost-effectiveness of the process used.

Further, modification in the heating of the off-gas reactor 1008 by extending the time of heating, or increasing the quantity of heat input, results in the additional conversion of the recovered sodium carbonate to sodium oxide (Na₂O). This additional heating time or quantity decomposes the sodium carbonate into sodium oxide and carbon dioxide product gas. The sodium oxide can be converted by reacting with water in a separate tank to sodium hydroxide, which, because it is even more reactive for carbon dioxide absorption than sodium carbonate, is highly desirable. Accordingly, the production of sodium hydroxide can greatly enhance the overall economics of this process. It should be noted that the heating is conducted using waste steam from the plant that is normally vented or otherwise wasted. In one embodiment, low pressure steam from the Low Pressure (LP) turbine stage of the plant is intercepted, used in non-contact coils to perform the heating described, then returned to the plant condensers. This in turn reduces the existing cooling load in the cooling tower cycle in the plant. Because every 1° F. reduction in this cooling load improves the thermal efficiency of the plant, this method of using the waste heat in this process is desirable for the plant.

In one test, an absorber blowdown stream at a pH of 10.4 had a composition as follows: 58 grams/liter (g/L) Na₂CO₃, 3.2 g/L NaHCO₃, and 0 g/L NaOH. After thermal regeneration or the addition of heat to this blowdown stream in a covered tank, the liquid effluent from the covered tank had a pH of 11.7 and a composition as follows: 61 g/L Na₂CO₃, 0 g/L NaHCO₃, and 5.1 g/L NaOH. This data shows that all of the sodium bicarbonate (NaHCO3, which is not effective in absorbing carbon dioxide) was converted to sodium carbonate (Na₂CO₃, which is effective in absorption) and further into sodium hydroxide (NaOH, which is even more effective than Na₂CO₃ in absorption).

It should be appreciated that the various processes and absorbers described above may be used to produce both gaseous carbon dioxide and calcium carbonate solids from the same system. It should further be appreciated that a computer system can be used to control the operation of the carbon dioxide absorber as well as a regeneration system, and a system operator could control the system to produce a desired ratio of carbon dioxide gas to calcium carbonate solids.

Various embodiments of the invention have been described above. The descriptions are intended to be illustrative of various embodiments of the present invention and are not intended to be limiting. It will be apparent to one of skill in the art that modifications may be made to the invention as described without departing from the scope of the claims set out below. For example, it is to be understood that although the various embodiments have been described in the context of a coal-fired boiler and the absorption of carbon dioxide from the corresponding flue gas, the methods and apparatuses of the various embodiments of the present invention may be applied to any gas stream from which it is desirable to remove carbon dioxide. It should also be appreciated that the present invention is adaptable to existing coal-fired flue gas systems that already comprise a sulfur dioxide scrubber. In this case, a carbon dioxide scrubber can be easily retrofitted into such a system. Further, it should be appreciated that in those embodiments where the carbon dioxide absorber is described as a single gas/liquid contactor that multiple contactors may be used or contactors with multiple absorption sections may be used.

What is claimed is:

1. A method for removing at least a portion of carbon dioxide in a gas stream and producing salable carbon dioxide, comprising:
contacting a gas stream comprising carbon dioxide with an alkaline liquid stream;
absorbing at least a portion of the carbon dioxide into the alkaline liquid stream to produce absorbed carbon dioxide;
mixing the alkaline liquid stream comprising the absorbed carbon dioxide with an acidic solution to off-gas carbon dioxide and produce a carbon dioxide gas; and
collecting the carbon dioxide gas.

2. The method of claim 1, further comprising:
reducing a moisture content of the carbon dioxide gas; and
compressing the carbon dioxide gas to compressed carbon dioxide gas.

3. A method for removing at least a portion of carbon dioxide in a gas stream and producing salable calcium chloride, comprising:
contacting a gas stream comprising carbon dioxide and hydrogen chloride with a calcium-based alkaline liquid stream;
absorbing at least a portion of the hydrogen chloride into the alkaline liquid stream to produce dissolved chloride;
mixing at least a portion of the alkaline liquid stream comprising the dissolved chloride with a calcium-based alkaline reagent to produce solid calcium chloride;
separating the solid calcium chloride from the portion of the alkaline liquid stream;
after said contacting, further contacting the gas stream with an alkaline liquid stream; and
absorbing at least a portion of the carbon dioxide into the alkaline liquid stream.

4. A method for removing at least a portion of carbon dioxide in a gas stream and producing salable carbon dioxide, comprising:
contacting a gas stream comprising carbon dioxide with an alkaline liquid stream comprising at least sodium bicarbonate;
absorbing at least a portion of the carbon dioxide into the alkaline liquid stream to produce absorbed carbon dioxide;
mixing at least a portion of the alkaline liquid stream comprising the absorbed carbon dioxide with reclaimed sodium carbonate to precipitate the sodium bicarbonate in the portion of the alkaline liquid stream and produce precipitated sodium bicarbonate;
heating the precipitated sodium bicarbonate to decompose the precipitated sodium bicarbonate to produce sodium carbonate; and
mixing the sodium carbonate with portion of the alkaline liquid stream.
